(19) United States
(12) Patent Application Publication
(10) Pub. No.: US 2025/0294250 A1
(43) Pub. Date: Sep. 18, 2025

(54) EXPOSURE CONTROL DEVICE, OPERATION METHOD FOR EXPOSURE CONTROL DEVICE, OPERATION PROGRAM FOR EXPOSURE CONTROL DEVICE, FOCUS CONTROL DEVICE, AND IMAGING APPARATUS

(71) Applicant: FUJIFILM Corporation, Tokyo (JP)

(72) Inventors: Hinako SUZUKI, Saitama-shi (JP); Ryosuke NAGAMI, Saitama-shi (JP)

(73) Assignee: FUJIFILM Corporation, Tokyo (JP)

(21) Appl. No.: 19/073,011

(22) Filed: Mar. 7, 2025

(30) Foreign Application Priority Data
Mar. 14, 2024 (JP) 2024-040467
Nov. 5, 2024 (JP) 2024-193383

(51) Int. Cl. H04N 23/67; H04N 23/71; H04N 23/86

(52) U.S. Cl. CPC H04N 23/672; H04N 23/71; H04N 23/86

(57) ABSTRACT

An imaging apparatus includes a controller that is an exposure control device that controls exposure of an imaging element including a normal pixel for imaging a subject and a phase-difference detection pixel for detecting a phase difference. A CPU of the controller functions as a second exposure condition setting unit. The second exposure condition setting unit performs exposure correction processing according to a difference between a maximum brightness value of the phase-difference detection pixel in a focus adjustment region and a saturation level.

### CROSS-REFERENCE TO RELATED APPLICATION

This application claims priority from Japanese Patent Application No. 2024-040467, filed Mar. 14, 2024, and Japanese Patent Application No. 2024-193383, filed Nov. 5, 2024, the disclosure of which is incorporated herein by reference in its entirety.

### BACKGROUND OF THE INVENTION

### Technical Field

The technology of the present disclosure relates to an exposure control device, an operation method for an exposure control device, an operation program for an exposure control device, a focus control device, and an imaging apparatus.

### Related Art

An imaging apparatus disclosed in JP2014-178391A comprises an imaging element, a focus detection unit, a saturation region detection unit, and an exposure controller. In the imaging element, at least some of a plurality of imaging pixels are configured of pixels having a focus detection function. The focus detection unit detects a defocus amount by using a signal acquired from the pixel having the focus detection function in a plurality of focus detection regions provided in the imaging element. The saturation region detection unit detects, as a saturation region detection value, the number of regions in which the signal is saturated among the plurality of focus detection regions. The exposure controller controls exposure in a case where the signal is acquired from the pixel having the focus detection function, using the saturation region detection value detected by the saturation region detection unit.

### SUMMARY

One embodiment according to the technology of the present disclosure provides an exposure control device, an operation method for an exposure control device, a non-transitory computer-readable storage medium storing an operation program for an exposure control device, a focus control device, and an imaging apparatus that are capable of improving focusing accuracy.

An exposure control device according to an aspect of the present disclosure is an exposure control device that controls exposure of an imaging element including a normal pixel for imaging a subject and a phase-difference detection pixel for detecting a phase difference, the exposure control device comprising a processor. The processor is configured to perform exposure correction processing according to a difference between a maximum brightness value of the phase-difference detection pixel in a set region and a saturation level.

It is preferable that the processor is configured to calculate an exposure correction amount based on the difference, as the exposure correction processing, and perform the exposure to the phase-difference detection pixel based on the exposure correction amount.

It is preferable that the saturation level is set to a value of an upper limit at which the maximum brightness value of the phase-difference detection pixel in the set region is not saturated.

It is preferable that the processor is configured to change the saturation level according to the subject.

It is preferable that the processor is configured to change the saturation level according to a subject class determined by a machine learning model.

It is preferable that a filter of a specific color is disposed in the phase-difference detection pixel, and the processor is configured to set, in a case where a ratio of the subject of the specific color is equal to or greater than a first threshold value set in advance, the saturation level higher than in a case where the ratio of the subject of the specific color is less than the first threshold value.

It is preferable that the processor is configured to calculate the maximum brightness value of the phase-difference detection pixel from a maximum brightness value of the normal pixel in the set region in a case where the subject is imaged with the normal pixel at a set exposure.

It is preferable that the maximum brightness value of the normal pixel is obtained by comparing any one of individual brightness values of the normal pixel in the set region, average values of the brightness values of a plurality of the normal pixels that are adjacent to or close to each other in the set region, or maximum values of the brightness values of the plurality of the normal pixels that are adjacent to or close to each other in the set region.

It is preferable that the processor is configured to calculate the maximum brightness value of the phase-difference detection pixel by multiplying a sensitivity ratio between the normal pixel and the phase-difference detection pixel by the maximum brightness value of the normal pixel.

It is preferable that the sensitivity ratio is changed according to a position of the normal pixel having the maximum brightness value. Further, it is preferable that the sensitivity ratio is changed according to a position of the set region.

It is preferable that the processor is configured to change the set region in a case of a backlit scene. More specifically, it is preferable that the processor is configured to set, in a case of the backlit scene, the set region to be narrower than in a case of a scene other than the backlit scene.

It is preferable that the processor is configured to, in a case where there are two peaks of a distribution of brightness values of the normal pixels in the set region or in a case where there are a plurality of inflection points of the distribution, employ a maximum brightness value at a peak on a low brightness side among the peaks of the distribution as the maximum brightness value of the normal pixel used in a case of calculating the maximum brightness value of the phase-difference detection pixel.

It is preferable that the processor is configured to, in a case of a backlit scene or a night scene, employ the maximum brightness value at the peak on the low brightness side as the maximum brightness value of the normal pixel used in a case of calculating the maximum brightness value of the phase-difference detection pixel.

It is preferable that the processor is configured to employ a median value of the maximum brightness values of the normal pixels obtained in a plurality of consecutive frames as the maximum brightness value of the normal pixel used in a case of calculating the maximum brightness value of the phase-difference detection pixel.

It is preferable that, the processor is configured to detect the normal pixels that have reached the saturation level in the set region, and in a case where a ratio of the normal pixels that have reached the saturation level is equal to or less than a second threshold value set in advance, perform exposure correction processing according to the difference.

It is preferable that the processor is configured to determine whether a distribution of the normal pixels that have reached the saturation level is sparse or dense, perform the exposure correction processing according to the difference in a case where the ratio is determined to be larger than the second threshold value and the distribution is determined to be sparse, perform the exposure correction processing according to a set exposure correction amount set in advance in a case where the ratio is determined to be larger than the second threshold value, the distribution is determined to be dense, and the ratio of the normal pixels in which the distribution is determined to be dense is less than a third threshold value set in advance, and not perform the exposure correction processing in a case where the ratio is determined to be larger than the second threshold value, the distribution is determined to be dense, and the ratio of the normal pixels in which the distribution is determined to be dense is equal to or larger than the third threshold value.

It is preferable that the processor is configured to calculate, as the exposure correction processing, an exposure correction amount based on the difference, perform the exposure to the phase-difference detection pixel based on the exposure correction amount, and in a case where an exposure time of an exposure condition according to the exposure correction amount is longer than a threshold value time set in advance, correct the exposure condition such that the exposure time is equal to or less than the threshold value time.

It is preferable that the processor is configured to calculate, as the exposure correction processing, an exposure correction amount based on the difference, perform exposure to the phase-difference detection pixel based on the exposure correction amount, and, in continuous capturing in which the exposure to the phase-difference detection pixel is performed during image recording, and in a case where an exposure time of an exposure condition according to the exposure correction amount is longer than a threshold value time set in advance, correct the exposure condition such that the exposure time is equal to or less than the threshold value time.

An operation method for an exposure control device according to an aspect of the present disclosure is an operation method for an exposure control device that controls exposure of an imaging element including a normal pixel for imaging a subject and a phase-difference detection pixel for detecting a phase difference, the operation method comprising performing exposure correction processing according to a difference between a maximum brightness value of the phase-difference detection pixel in a set region and a saturation level.

A non-transitory computer-readable storage medium storing an operation program for an exposure control device according to an aspect of the present disclosure is an operation program for an exposure control device that controls exposure of an imaging element including a normal pixel for imaging a subject and a phase-difference detection pixel for detecting a phase difference, the program causing a computer to execute a process comprising performing exposure correction processing according to a difference between a maximum brightness value of the phase-difference detection pixel in a set region and a saturation level.

A focus control device according to an aspect of the present disclosure comprises the exposure control device described above.

An imaging apparatus according to an aspect of the present disclosure comprises the exposure control device described above.

### BRIEF DESCRIPTION OF THE DRAWINGS

FIG. 1 is a diagram showing a configuration of an imaging apparatus.

FIG. 2 is a diagram showing an arrangement of pixels of an imaging element.

FIG. 3 is a diagram showing a configuration of a normal pixel.

FIG. 4 is a diagram showing a configuration of a first phase-difference detection pixel.

FIG. 5 is a diagram showing a configuration of a second phase-difference detection pixel.

FIG. 6 is a graph showing a phase difference between a signal for first calculation and a signal for second calculation.

FIG. 7 is a block diagram showing a detailed configuration of a controller.

FIG. 8 is a block diagram showing a processing unit of a CPU.

FIG. 9 is a flowchart showing a procedure of calculating a maximum brightness value of a phase-difference detection pixel.

FIG. 10 is a graph showing a sensitivity ratio of the normal pixel and the phase-difference detection pixel to a position, and a diagram showing a sensitivity ratio according to a position of the normal pixel having the maximum brightness value.

FIG. 11 is a diagram showing a state in which the maximum brightness value of the phase-difference detection pixel is calculated from the maximum brightness value of the normal pixel, and an exposure correction amount.

FIG. 12 is a flowchart showing a processing procedure of the controller.

FIG. 13 is a flowchart showing another example of the procedure of calculating the maximum brightness value of the phase-difference detection pixel.

FIG. 14 is a flowchart showing still another example of the procedure of calculating the maximum brightness value of the phase-difference detection pixel.

FIG. 15 is a diagram showing an aspect in which a median value of maximum brightness values of normal pixels, which is obtained in a plurality of consecutive frames, is employed.

FIG. 16 is a diagram showing a processing unit of a second embodiment.

FIG. 17 is a diagram showing a saturation level of a dark green subject and a saturation level of a non-dark green subject.

FIG. 18 is a diagram showing a processing unit of a third embodiment.

FIG. 19 is a diagram showing a region for obtaining the maximum brightness value in a case of not being a backlit scene and in a case of the backlit scene.

FIGS. 20A and 20B are diagrams showing a method of obtaining the maximum brightness value of the normal pixel, in which FIG. 20A shows a case of not being the backlit scene or a night scene, and FIG. 20B shows a case of the backlit scene or the night scene.

FIG. 21 is a block diagram showing a processing unit of a fourth embodiment.

FIGS. 22A and 22B are diagrams showing a method of determining whether a distribution of saturated pixels is sparse or dense, in which FIG. 22A shows a case where the number of saturated pixels present in a determination region centered on a reference saturated pixel is less than 80% and the distribution is determined to be sparse, and FIG. 22B shows a case where the number of saturated pixels present in the determination region centered on the reference saturated pixel is 80% or more and the distribution is determined to be dense.

FIG. 23 is a diagram showing another example of the method of determining whether the distribution of the saturated pixels is sparse or dense.

FIG. 24 is a flowchart showing a processing procedure of the fourth embodiment.

FIG. 25 is a diagram showing a method of dealing with a case where an exposure time according to a calculated exposure correction amount is longer than an exposure time according to a set exposure correction amount by a first threshold value time.

FIG. 26 is a timing chart of continuous capturing in which exposure for focus adjustment is performed during image recording.

FIG. 27 is a diagram showing a method of dealing with a case where the exposure time according to the calculated exposure correction amount is longer than a second threshold value time in the continuous capturing shown in FIG. 26.

FIG. 28 is a timing chart of the continuous capturing before and after a second exposure condition is corrected.

FIG. 29 is a diagram showing an aspect in which the maximum brightness value of the phase-difference detection pixel is corrected by using a difference between a photometric value by the normal pixel and a photometric value by the phase-difference detection pixel.

### DETAILED DESCRIPTION

### First Embodiment

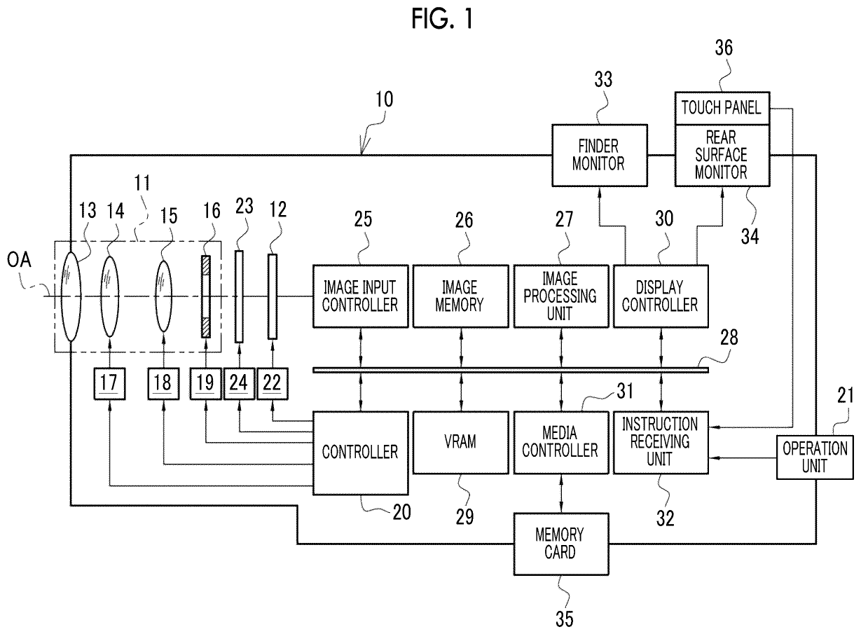

As shown in FIG. 1 as an example, an imaging apparatus 10 is, for example, a mirrorless single-lens digital camera, and comprises an imaging optical system 11 and an imaging element 12. The imaging optical system 11 has a plurality of types of lenses for forming an image of subject light on the imaging element 12. Specifically, the imaging optical system 11 has an objective lens 13, a focus lens 14, and a zoom lens 15. Each of these lenses 13 to 15 is disposed in this order from an object side (subject side) toward an image formation side (imaging element 12 side). Although simplified in FIG. 1, each of the lenses 13 to 15 is actually a lens group in which a plurality of lenses are combined. The imaging optical system 11 also has a stop 16. The stop 16 is disposed closest to the image formation side in the imaging optical system 11. The imaging apparatus 10 may be a type in which a lens barrel with built-in the imaging optical system 11 and the like is integrated with a main body with built-in the imaging element 12 and the like, or may be a so-called lens interchangeable type in which the lens barrel and the main body are separate bodies.

The focus lens 14 is provided with a focus lens driving mechanism 17, the zoom lens 15 is provided with a zoom lens driving mechanism 18, and the stop 16 is provided with a stop driving mechanism 19. The focus lens driving mechanism 17 holds the focus lens 14, and includes a cam ring for focusing in which a cam groove is formed on the outer periphery of the focus lens 14, a motor for focusing that rotates the cam ring for focusing around an optical axis OA to move the cam ring for focusing along the optical axis OA, a driver of the motor for focusing, and the like. Similarly, the zoom lens driving mechanism 18 holds the zoom lens 15, and includes a cam ring for zoom in which a cam groove is formed on the outer periphery of the zoom lens 15, a motor for zoom that rotates the cam ring for zoom around the optical axis OA to move the cam ring for zoom along the optical axis OA, a driver of the motor for zoom, and the like. The stop driving mechanism 19 includes a motor for stop that opens and closes a plurality of stop leaf blades of the stop 16, a driver of the motor for stop, and the like.

The motor for focusing, the motor for zoom, and the motor for stop are, for example, stepping motors. In this case, positions of the focus lens 14 and the zoom lens 15 on the optical axis OA and an aperture of the stop 16 can be derived from drive amounts of the motor for focusing, the motor for zoom, and the motor for stop. A position sensor may be provided to detect the positions of the focus lens 14 and the zoom lens 15, instead of the drive amounts of the motor for focusing and the motor for zoom.

An electric component, such as the motor or the driver, of each of the driving mechanisms 17 to 19 is connected to a controller 20. The electric component of each of the driving mechanisms 17 to 19 is driven under the control of the controller 20. More specifically, the controller 20 issues a drive signal in response to an instruction from a user, which is input via an operation unit 21, to drive the electric component of each of the driving mechanisms 17 to 19. For example, in a case where an instruction to change an angle of view to a telephoto side is input via an angle-of-view change switch of the operation unit 21, the controller 20 issues, to the driver of the motor for zoom of the zoom lens driving mechanism 18, the drive signal to move the zoom lens 15 to the telephoto side.

The motor for focusing, the motor for zoom, and the motor for stop output the drive amounts to the controller 20. The controller 20 derives the position of the focus lens 14 and the position of the zoom lens 15 on the optical axis OA and the aperture of the stop 16 from the drive amounts.

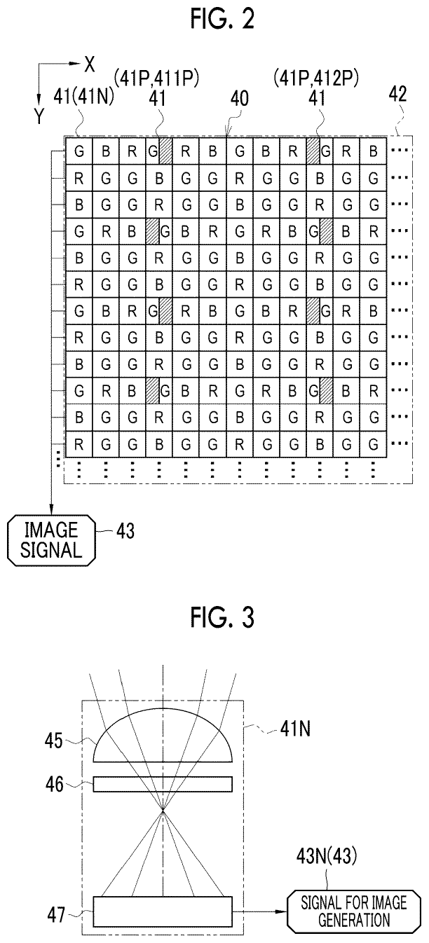

The imaging element 12 is, for example, a complementary metal-oxide-semiconductor (CMOS) image sensor, and has an imaging surface 42 (refer to FIG. 2) that images the subject light. The imaging element 12 is disposed such that a center of the imaging surface 42 matches the optical axis OA and the imaging surface 42 is orthogonal to the optical axis OA. The terms “match” and “orthogonal” as used herein mean not only perfect match and orthogonality but also match and orthogonality in a sense including an error generally allowed in the technical field to which the technique of the present disclosure belongs.

An imaging element driver 22 is connected to the imaging element 12. The imaging element driver 22 is connected to the controller 20. The imaging element driver 22 performs, under the control of the controller 20, supplying of a vertical scanning signal and a horizontal scanning signal to the imaging element 12, or the like to control an imaging timing of the subject light by the imaging element 12. Further, the imaging element driver 22 adjusts a gain applied to an image signal 43 (refer to FIG. 2) output from the imaging element 12 to change an international organization for standardization (ISO) sensitivity of an image to be obtained.

A shutter 23 is provided between the imaging optical system 11 and the imaging element 12. The shutter 23 is, for example, a focal-plane shutter having a front curtain and a rear curtain. A shutter driving mechanism 24 is connected to the shutter 23. The shutter driving mechanism 24 includes an electromagnet that holds the front curtain and the rear curtain and releases the holding thereof to cause the front curtain and the rear curtain to travel, a driver of the electromagnet, and the like. The shutter driving mechanism 24 is driven to open and close the shutter 23 under the control of the controller 20.

The controller 20 is connected to each unit such as an image input controller 25, an image memory 26, and an image processing unit 27, through a busline 28. In addition, the busline 28 is connected to a video random access memory (VRAM) 29, a display controller 30, a media controller 31, an instruction receiving unit 32, and the like. Although not shown, the busline 28 is also connected to a strobe driving controller that controls the drive of a strobe device, an external communication interface (I/F) for communicating with an external device via a connection terminal such as a universal serial bus (USB) terminal or a wireless communication I/F, and the like.

Image data obtained by imaging the subject light is input to the image input controller 25 from the imaging element 12. The image input controller 25 outputs the image data to the image memory 26. The image memory 26 is, for example, a synchronous dynamic random access memory (SDRAM), and temporarily stores the image data.

The image processing unit 27 reads out unprocessed image data from the image memory 26. The image processing unit 27 performs various types of image processing on the image data. The various types of image processing are, for example, offset correction processing, sensitivity correction processing, pixel interpolation processing, white balance correction processing, gamma correction processing, demosaicing, brightness signal and color difference signal generation processing, contour enhancement processing, and color correction processing. The image processing unit 27 writes the image data subjected to the various types of image processing back to the image memory 26.

The image data that is subjected to the various types of image processing and is displayed as a live view image (also referred to as through-image) is input into the VRAM 29 from the image memory 26. The VRAM 29 has a region in which the image data for two consecutive frames is stored. The image data stored in the VRAM 29 is sequentially rewritten to new image data. The VRAM 29 sequentially outputs, to the display controller 30, newer image data of the image data for two consecutive frames.

The display controller 30 has a so-called video encoder function of converting the image data from the VRAM 29 into video data and outputting the video data to any one of a finder monitor 33 or a rear surface monitor 34. Accordingly, the user can visually recognize the live view image through any one of the finder monitor 33 or the rear surface monitor 34. A display frame rate of the live view image is, for example, 60 frames per second (fps).

Which one of the finder monitor 33 and the rear surface monitor 34 the video data is output to is decided as follows, for example. That is, a pupil detection sensor is provided in a finder. In a case where the pupil detection sensor detects that the user looks into the finder, the video data is output to the finder monitor 33. On the contrary, in a case where the pupil detection sensor detects that the user does not look into the finder, the video data is output to the rear surface monitor 34.

In a case where an instruction to start capturing a static image or a video is issued via a fully push-operated release button of the operation unit 21, the image processing unit 27 performs compression processing on the image data of the image memory 26. In a case of the static image, the image processing unit 27 performs, for example, the compression processing of a joint photographic experts group (JPEG) format on the image data. In a case of the video, the image processing unit 27 performs, for example, the compression processing of a moving picture experts group (MPEG) format on the image data. The image processing unit 27 outputs, to the media controller 31, the image data subjected to the compression processing.

The media controller 31 records, in a memory card 35, the image data subjected to the compression processing from the image processing unit 27. The memory card 35 is attachably and detachably mounted in a memory card slot (not illustrated).

In a case where an image playback mode is selected via a mode selector switch of the operation unit 21, the media controller 31 reads out the image data from the memory card 35 to output the image data to the image processing unit 27. The image processing unit 27 performs expansion processing on image data from the memory card 35. The image processing unit 27 outputs the image data after the expansion processing to the display controller 30. The display controller 30 converts the image data into the video data and outputs the video data to the rear surface monitor 34. Accordingly, the user can visually recognize a reproduction image through the rear surface monitor 34.

The instruction receiving unit 32 receives various operation instructions input from the user via a touch panel 36 that is integrally provided with the operation unit 21 and the rear surface monitor 34. The instruction receiving unit 32 outputs the received various operation instructions to the controller 20 through the busline 28.

As described above, the operation unit 21 includes the angle-of-view change switch, the release button, and the mode selector switch. The release button is a two-stage push button capable of performing a half push operation and a full push operation. An instruction to prepare capturing of a static image or a video is issued by a half push operation of the release button, and the instruction to start capturing a static image or a video is issued by the full push operation of the release button. In addition to the above, the operation unit 21 further includes a menu button for displaying various setting menus on the rear surface monitor 34, a cross key used for numerical value setting, switching of options, and the like, and a confirmation button that is operated in a case of setting confirmation and the like. The touch panel 36 is superimposed on a display surface of the rear surface monitor 34. The touch panel 36 detects contact with a finger of the user or a dedicated indicator such as a stylus pen to recognize the various operation instructions from the user.

The modes that can be switched by the mode selector switch include a static-image capturing mode, a video imaging mode, an image playback mode, a setting mode, and the like. The static-image capturing mode includes not only a normal capturing mode in which one static image is captured but also a continuous capturing mode in which static images are continuously captured at a predetermined capturing interval (for example, frame rate of 5 fps to 10 fps). The continuous capturing mode is activated, for example, in a case where a full push state of the release button continues for a predetermined time or longer (for example, one second or longer). The continuous capturing mode ends in a case where the full push state of the release button is released. In the normal imaging mode, so-called quick imaging is also possible in which imaging is performed by half pressing the release button and then fully pressing the release button without waiting for an end of an imaging preparation operation.

As shown in FIG. 2 as an example, the imaging element 12 is provided with a photoelectric conversion unit 40. The photoelectric conversion unit 40 is configured of a plurality of pixels 41 two-dimensionally arranged along an X direction and a Y direction. The plurality of pixels 41 form the imaging surface 42. As is well known, the pixel 41 is configured of a micro lens 45, a color filter 46, and a photoelectric conversion element 47 such as a photodiode (refer to FIGS. 3 to 5 for all). The X direction and the Y direction are a horizontal direction and a vertical direction in a state where a bottom surface of the imaging apparatus 10 is placed on a horizontal plane.

Scanning lines parallel to the X direction are wired between rows of the pixels 41. Further, signal lines parallel to the Y direction are wired between columns of the pixels 41. (The photoelectric conversion element 47 of) the pixel 41 is connected to the signal line via an amplifier and a switch. The scanning line is also connected to the switch. In a case of the accumulation operation that accumulates a signal charge according to the subject light in (the photoelectric conversion element 47 of) the pixel 41, an off signal is supplied as the vertical scanning signal through the scanning line to turn off the switch. In a case of the readout operation that reads out an image signal (voltage signal) 43 according to the signal charge from (the photoelectric conversion element 47 of) the pixel 41, an on signal is supplied as the vertical scanning signal through the scanning line to turn on the switch. An end of the signal line is connected to a correlated double sampling (CDS) circuit and an analog to digital converter (ADC) circuit. The CDS circuit performs sampling two correlation pile on the image signal 43 input through the signal line. The ADC circuit converts the image signal 43 subjected to the sampling two correlation pile into a digital image signal 43.

The pixels 41 are divided, depending on types of the color filter 46, into three types of a green pixel (denoted as “G” in FIG. 2) having sensitivity to light in a green wavelength range, a red pixel (denoted as “R” in FIG. 2) having sensitivity to light in a red wavelength range, and a blue pixel (denoted as “B” in FIG. 2) having sensitivity to light in a blue wavelength range. The three types of the pixels 41 are regularly arranged in a predetermined array. As the predetermined array, a so-called Bayer array is exemplified in which two green pixels, one blue pixel, and one red pixel are arranged in vertical and horizontal 2×2 pixels.

The pixel 41 includes a normal pixel 41N and a phase-difference detection pixel 41P. The phase-difference detection pixel 41P further includes a first phase-difference detection pixel 411P and a second phase-difference detection pixel 412P. The normal pixel 41N has three types of pixels of a green pixel, a blue pixel, and a red pixel, but the phase-difference detection pixel 41P has only the green pixel. The green color is an example of “specific color” according to the technology of the present disclosure.

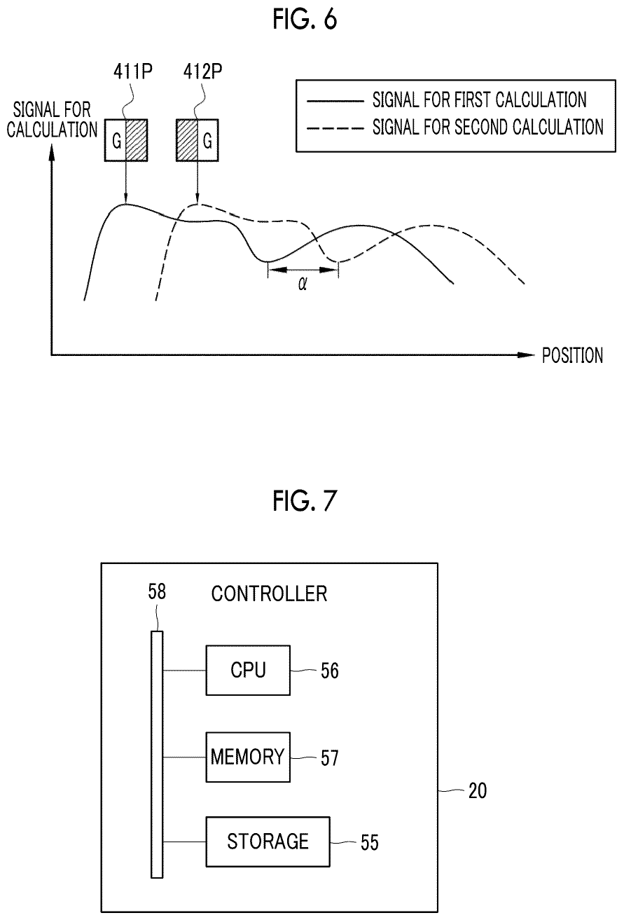

The phase-difference detection pixels 41P are arranged at predetermined spacings in the X direction and the Y direction. In FIG. 2, the phase-difference detection pixels 41P are arranged at a spacing of five pixels in the X direction and at a spacing of two pixels in the Y direction. Further, in the phase-difference detection pixel 41P, the first phase-difference detection pixel 411P and the second phase-difference detection pixel 412P are disposed to alternately appear in the X direction and the Y direction. For example, in a case where a fourth row is viewed, the phase-difference detection pixels 41P are arranged, from left to right, in an order of the second phase-difference detection pixels 412P, the first phase-difference detection pixels 411P, and the like. Further, for example, in a case where a tenth column is viewed, the phase-difference detection pixels 41P are disposed, from top to bottom, in an order of the second phase-difference detection pixel 412P, the first phase-difference detection pixel 411P, the second phase-difference detection pixel 412P, the first phase-difference detection pixel 411P, and the like. The first phase-difference detection pixel 411P and the second phase-difference detection pixel 412P adjacent to each other in the X direction and the Y direction configure one set for detecting a phase difference α (refer to FIG. 6).

As shown in FIGS. 3 to 5 as an example, the normal pixel 41N, the first phase-difference detection pixel 411P, and the second phase-difference detection pixel 412P have the same basic configuration, and are configured of the micro lens 45, the color filter 46, and the photoelectric conversion element 47, which are disposed in order from the object side.

As shown in FIG. 3, the photoelectric conversion element 47 of the normal pixel 41N outputs, as the image signal 43, a signal for image generation 43N according to the subject light that is condensed by the micro lens 45 and transmitted through the color filter 46. The signal for image generation 43N is stored in the image memory 26 as a part of the image data.

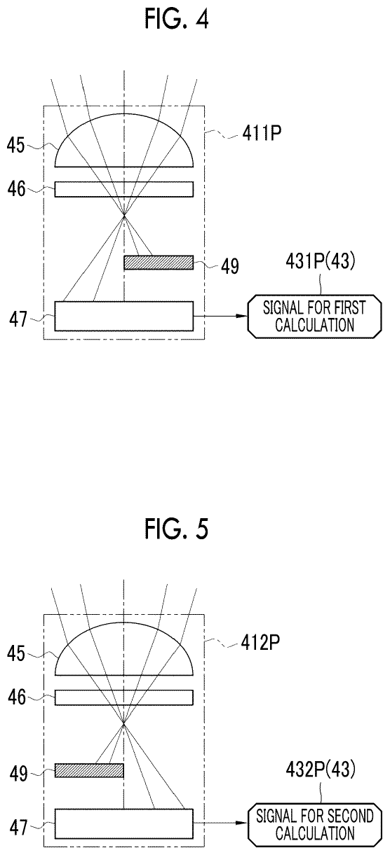

As shown in FIGS. 4 and 5, a light shielding member 49 is disposed between the color filter 46 and the photoelectric conversion element 47 for the first phase-difference detection pixel 411P and the second phase-difference detection pixel 412P. The light shielding member 49 is not disposed in the normal pixel 41N. The light shielding member 49 of the first phase-difference detection pixel 411P shields a right half of the photoelectric conversion element 47, as viewed from the object side. On the contrary, the light shielding member 49 of the second phase-difference detection pixel 412P shields a left half of the photoelectric conversion element 47, as viewed from the object side.

The photoelectric conversion element 47 of the first phase-difference detection pixel 411P outputs, as the image signal 43, a signal for first calculation 431P according to the subject light that is condensed by the micro lens 45 and transmitted through the color filter 46, and whose right half is shielded by the light shielding member 49. On the contrary, the photoelectric conversion element 47 of the second phase-difference detection pixel 412P outputs, as the image signal 43, a signal for second calculation 432P according to the subject light that is condensed by the micro lens 45 and transmitted through the color filter 46, and whose left half is shielded by the light shielding member 49. The signal for first calculation 431P and the signal for second calculation 432P are stored in the image memory 26 as a part of the image data, similarly to the signal for image generation 43N. Hereinafter, in a case where the signals do not need to be particularly distinguished from each other, the signal for first calculation 431P and the signal for second calculation 432P are collectively denoted as a signal for calculation 43P.

As shown in FIG. 6 as an example, the phase difference α appears between the signal for first calculation 431P and the signal for second calculation 432P, which are output from the first phase-difference detection pixel 411P and the second phase-difference detection pixel 412P adjacent to each other in the X direction and the Y direction. With the phase difference α, it is possible to know a movement direction and amount of the focus lens 14 to obtain a focusing position. The imaging apparatus 10 performs automatic focus control of calculating the focusing position of the focus lens 14 based on the phase difference α and automatically moving the focus lens 14 to the focusing position.

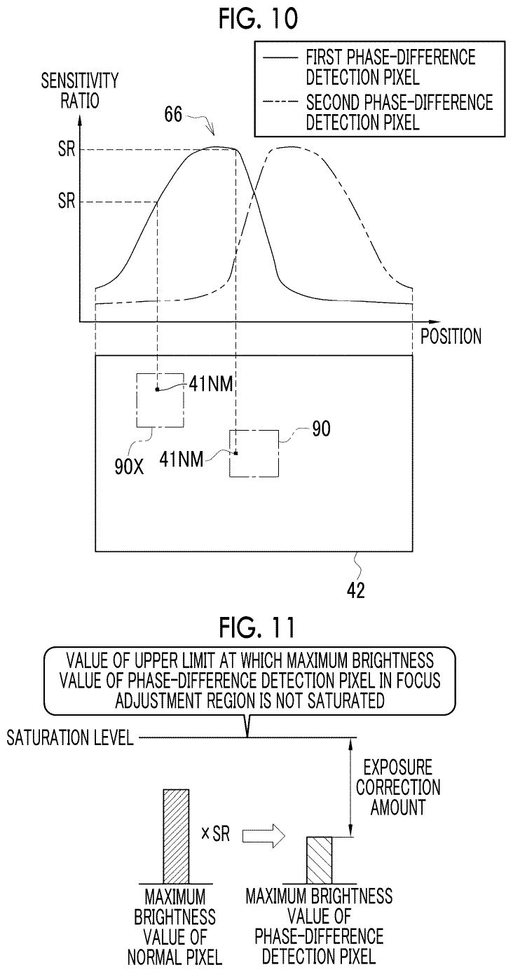

A region (hereinafter denoted as focus adjustment region) 90 (refer to FIG. 10) for calculating the focusing position is a region set in advance in a center portion of the imaging surface 42. Further, the focus adjustment region 90 may be a region designated by the user, or a region surrounding a specific subject recognized by a well-known subject recognition technology. The specific subject is a pupil, face, or body of a person, a pupil, face, or body of an animal, or a head, body, or the like of a vehicle such as an automobile, a railway vehicle, or an airplane. Here, the pupil of the person or the animal is a pupil, that is, a so-called iris. The face of the person or the animal is a portion having, for example, a forehead, chews, a chin, eyes, a nose, a mouth, ears, and the like. The body of the person or the animal is a portion excluding the head, neck, limbs, and tail. The head of the vehicle is a front body in a case of an automobile, a portion of a head car having a destination display, a front window, a headlight, or the like in a case of a railway car, and a nose portion having a radome, front window, or the like in a case of an airplane. The body of the vehicle is the entire body excluding wheels in a case of an automobile, the entire body excluding wheels in a case of a railway car regardless of whether the car is a head car, an intermediate car, or a last car, and the entire body excluding a head, main wings, a caudal wing, and the like in a case of an airplane. An example of the subject recognition technology includes a technology of using a machine learning model such as a convolutional neural network.

As the name indicates, the signal for image generation 43N is used to generate an image such as the live view image. On the contrary, the signal for calculation 43P is used only to calculate the phase difference α and is not used to generate the image. For this reason, in the pixel interpolation processing, the image processing unit 27 interpolates a pixel value of the phase-difference detection pixel 41P by using the signal for image generation 43N of the normal pixel 41N around the phase-difference detection pixel 41P.

Since the light shielding member 49 is provided, an amount of subject light that can be incorporated into is smaller in the phase-difference detection pixel 41P than in the normal pixel 41N. Thus, in a case where the exposure is performed under an exposure condition set with reference to the normal pixel 41N, a light amount is insufficient for the phase-difference detection pixel 41P, and a signal component for calculating the phase difference α of the signal for calculation 43P is buried in a noise component. In the technology of the present disclosure, as will be described below, the exposure condition is corrected with reference to the phase-difference detection pixel 41P, and the exposure is performed under the corrected exposure condition to increase the light amount to be incorporated into the phase-difference detection pixel 41P and to improve a signal-noise (SN) ratio of the signal for calculation 43P. The “exposure” refers to the amount of light incident on the imaging element 12 through the imaging optical system 11. Thus, for example, “increasing the exposure” means increasing the amount of light incident on the imaging element 12. On the other hand, the “exposure” refers to an act of forming an image of the subject light on the imaging element 12.

As shown in FIG. 7 as an example, the controller 20 comprises a storage 55, a central processing unit (CPU) 56, and a memory 57. The storage 55, the CPU 56, and the memory 57 are connected to each other via a busline 58. The controller 20 is an example of “exposure control device”, “focus control device”, and “computer” according to the technology of the present disclosure.

The storage 55 is a non-volatile storage device such as an electrically erasable programmable read-only memory (EEPROM). The storage 55 stores various programs, various types of data associated with the various programs, and the like. Instead of the EEPROM, a ferroelectric random access memory (FeRAM) or a magnetoresistive random access memory (MRAM) may be used as the storage 55.

The memory 57 is a work memory for the CPU 56 to execute the processing. The CPU 56 loads the program stored in the storage 55 into the memory 57 to execute the processing according to the program. With the above, the CPU 56 controls each unit of the imaging apparatus 10 in an integrated manner. The CPU 56 is an example of “processor” according to the technology of the present disclosure. The memory 57 may be built into the CPU 56.

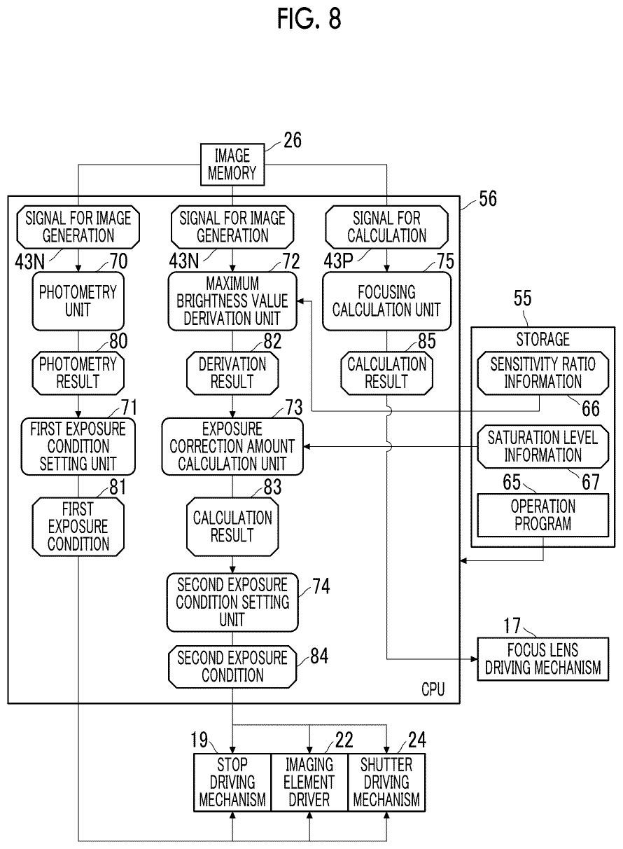

As shown in FIG. 8 as an example, the storage 55 stores an operation program 65. The operation program 65 is a program that causes the CPU 56 to perform the automatic focus control and the like. That is, the operation program 65 is an example of “operation program of exposure control device” according to the technology of the present disclosure. In addition to the operation program 65, the storage 55 also stores sensitivity ratio information 66 and saturation level information 67.

In a case where the operation program 65 is started, the CPU 56 cooperates with the memory 57 and the like to function as a photometry unit 70, a first exposure condition setting unit 71, a maximum brightness value derivation unit 72, an exposure correction amount calculation unit 73, a second exposure condition setting unit 74, and a focusing calculation unit 75. The CPU 56 also functions as various processing units, in addition to these processing units 70 to 75.

The photometry unit 70 reads out the signal for image generation 43N from the image memory 26. In the imaging preparation operation by the half-press operation of the release button, the photometry unit 70 performs the photometry on the brightness of the subject before the static-image capturing. The exposure that performs the photometry on the brightness of the subject before the static-image capturing is denoted as exposure for photometry. The photometry unit 70 calculates a brightness value from the signals for image generation 43N of a plurality of normal pixels 41N for photometry that are equally dispersed on the imaging surface 42, in the signals for image generation 43N obtained by the exposure for photometry. An average value of the calculated brightness values is calculated, and the average value of the brightness values is derived as the brightness of the subject. The photometry unit 70 outputs a photometry result 80 of the brightness of the subject to the first exposure condition setting unit 71. The average value may be an arithmetic average value or a weighted average value.

The first exposure condition setting unit 71 sets a first exposure condition 81 according to the photometry result 80. The first exposure condition 81 is to obtain an image with the set exposure. Further, the first exposure condition 81 relates to exposure for calculating an exposure correction amount according to the phase-difference detection pixel 41P (hereinafter denoted as exposure for exposure correction amount calculation), which is performed after the exposure for photometry. Furthermore, the first exposure condition 81 relates to the static-image capturing (hereinafter denoted as main exposure) by the full push operation of the release button. Specifically, the first exposure condition 81 is a combination of a shutter speed of the shutter 23, the aperture stop (may be referred to as stop value or F number) of the stop 16, and the gain applied to the image signal 43. The first exposure condition setting unit 71 outputs the first exposure condition 81 to the stop driving mechanism 19, the imaging element driver 22, and the shutter driving mechanism 24. The stop driving mechanism 19, the imaging element driver 22, and the shutter driving mechanism 24 perform, under the first exposure condition 81, the exposure for exposure correction amount calculation. The “set exposure” is set by an automatic exposure function provided in the imaging apparatus 10. Alternatively, the “set exposure” is set by the user as appropriate.

The maximum brightness value derivation unit 72 reads out, from the image memory 26, the signal for image generation 43N obtained in the exposure for exposure correction amount calculation. The maximum brightness value derivation unit 72 derives, from the signal for image generation 43N, a maximum brightness value of the phase-difference detection pixel 41P with reference to the sensitivity ratio information 66. The maximum brightness value derivation unit 72 outputs a derivation result 82 of the maximum brightness value of the phase-difference detection pixel 41P to the exposure correction amount calculation unit 73. The maximum brightness value of the phase-difference detection pixel 41P is a maximum value of the brightness values of the phase-difference detection pixels 41P in the focus adjustment region 90.

The exposure correction amount calculation unit 73 calculates the exposure correction amount according to the phase-difference detection pixel 41P, based on the saturation level information 67 and the maximum brightness value of the phase-difference detection pixel 41P of the derivation result 82. The exposure correction amount is a setting of increasing the exposure from the first exposure condition 81 in order to perform the exposure according to the phase-difference detection pixel 41P. The exposure correction amount calculation unit 73 outputs a calculation result 83 of the exposure correction amount to the second exposure condition setting unit 74.

The second exposure condition setting unit 74 performs exposure correction processing. More specifically, the second exposure condition setting unit 74 sets a second exposure condition 84 according to the calculation result 83 based on the first exposure condition 81. The second exposure condition 84 relates to exposure for performing focus adjustment by the focus lens 14 (hereinafter denoted as exposure for focus adjustment), which is performed after the exposure for exposure correction amount calculation. The second exposure condition 84 is also a combination of the shutter speed of the shutter 23, the aperture stop of the stop 16, and the gain applied to the image signal 43, as in the first exposure condition 81. However, since the exposure correction amount is set to increase the exposure as described above, the shutter speed of the second exposure condition 84 is set to a value slower than the first exposure condition 81 in order to increase an exposure time. The second exposure condition 84 is an example of “exposure condition according to exposure correction amount” according to the technology of the present disclosure. The second exposure condition setting unit 74 outputs the second exposure condition 84 to the stop driving mechanism 19, the imaging element driver 22, and the shutter driving mechanism 24. The stop driving mechanism 19, the imaging element driver 22, and the shutter driving mechanism 24 perform, under the second exposure condition 84, the exposure for focus adjustment. The exposure for focus adjustment is an example of “exposure to phase-difference detection pixel” according to the technology of the present disclosure. In the second exposure condition 84, the aperture of the stop 16 and the gain applied to the image signal 43 may be changed from the first exposure condition 81, in addition to or instead of the shutter speed.

Although not shown, the focusing calculation unit 75 receives, from the focus lens driving mechanism 17, an input of the drive amount of the motor for focusing. The focusing calculation unit 75 derives, from the drive amount, a current position of the focus lens 14 on the optical axis OA.

Further, the focusing calculation unit 75 reads out, from the image memory 26, the signal for calculation 43P obtained in the exposure for focus adjustment. Specifically, the signal for calculation 43P is data in which a plurality of signals for first calculation 431P output from the first phase-difference detection pixel 411P are two-dimensionally arranged in the X direction and the Y direction following the arrangement of the first phase-difference detection pixels 411P, and data in which a plurality of signals for second calculation 432P output from the second phase-difference detection pixel 412P are two-dimensionally arranged in the X direction and the Y direction following the arrangement of the second phase-difference detection pixels 412P. Therefore, the signal for calculation 43P can be handled as two-dimensional image data.

The focusing calculation unit 75 calculates the phase difference α shown in FIG. 6 from the signal for calculation 43P of the focus adjustment region 90. The focusing calculation unit 75 calculates, based on the phase difference α, the focusing position of the focus lens 14 in a case where the focus lens 14 is at the current position. The focusing calculation unit 75 outputs a calculation result 85 of the focusing position to the focus lens driving mechanism 17. The focus lens driving mechanism 17 moves the focus lens 14 to the focusing position. In a case where the current position of the focus lens 14 is the same as the focusing position, the focus lens driving mechanism 17 does nothing, and the focus lens 14 is not moved. Since a method of calculating the focusing position of the focus lens 14 based on the phase difference α is known, detailed description thereof will be omitted here.

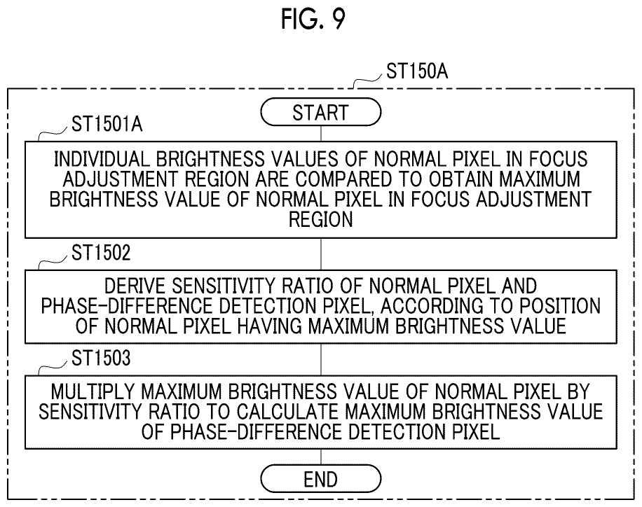

The maximum brightness value derivation unit 72 derives the maximum brightness value of the phase-difference detection pixel 41P in a procedure shown in step ST150A of a flowchart of FIG. 9 as an example. First, the maximum brightness value derivation unit 72 calculates the brightness value from the individual signals for image generation 43N of the normal pixel 41N in the focus adjustment region 90. The individual brightness values of the normal pixel 41N in the focus adjustment region 90 are compared to obtain the maximum brightness value of the normal pixel 41N in the focus adjustment region 90 (step ST1501A). The focus adjustment region 90 is an example of “set region” according to the technology of the present disclosure.

Next, as shown in FIG. 10 as an example, the maximum brightness value derivation unit 72 derives a sensitivity ratio SR of the normal pixel 41N and the phase-difference detection pixel 41P, according to a position of a normal pixel 41NM having the maximum brightness value, using the sensitivity ratio information 66 (step ST1502). The sensitivity ratio information 66 is information in which a sensitivity ratio between the normal pixel 41N and the first phase-difference detection pixel 411P and a sensitivity ratio between the normal pixel 41N and the second phase-difference detection pixel 412P corresponding to each position of the normal pixel 41N are registered. Two sensitivity ratios of the sensitivity ratio between the normal pixel 41N and the first phase-difference detection pixel 411P and the sensitivity ratio between the normal pixel 41N and the second phase-difference detection pixel 412P are obtained as the sensitivity ratio according to the position of the normal pixel 41NM having the maximum brightness value. The maximum brightness value derivation unit 72 derives, as the sensitivity ratio SR, a higher one of the sensitivity ratio between the normal pixel 41N and the first phase-difference detection pixel 411P and the sensitivity ratio between the normal pixel 41N and the second phase-difference detection pixel 412P. As described above, the sensitivity ratio is changed according to the position of the normal pixel 41NM having the maximum brightness value.

Further, in a case where the focus adjustment region 90 is the region designated by the user or the region surrounding a specific subject recognized by a well-known subject recognition technology, a position of the focus adjustment region 90 is not fixed. In this case, as shown in a focus adjustment region 90X which is a region designated by the user or a region surrounding a specific subject recognized by a well-known subject recognition technology, the sensitivity ratio SR is also changed according to a position of the focus adjustment region 90X. The sensitivity ratio is a ratio between a light amount of subject light incident on the normal pixel 41N and the light amount of subject light incident on the phase-difference detection pixel 41P, which is changed by being shielded by the light shielding member 49.

As shown in FIG. 11 as an example, the maximum brightness value derivation unit 72 multiplies the maximum brightness value of the normal pixel 41N obtained in step ST1501A by the sensitivity ratio derived in step ST1502 to calculate the maximum brightness value of the phase-difference detection pixel 41P (step ST1503). That is, the maximum brightness value derivation unit 72 calculates the maximum brightness value of the phase-difference detection pixel 41P from the maximum brightness value of the normal pixel 41N in the focus adjustment region 90 in a case where the normal pixel 41N images the subject with the set exposure.

The exposure correction amount calculation unit 73 calculates the exposure correction amount based on a difference between the maximum brightness value of the phase-difference detection pixel 41P and the saturation level. More specifically, the exposure correction amount calculation unit 73 calculates, as the exposure correction amount, the difference between the maximum brightness value of the phase-difference detection pixel 41P and the saturation level. Since the second exposure condition 84 is set from the exposure correction amount, the second exposure condition setting unit 74 causes the phase-difference detection pixel 41P to perform the exposure based on the exposure correction amount. In other words, the second exposure condition setting unit 74 performs processing of increasing the exposure by the difference between the maximum brightness value of the phase-difference detection pixel 41P and the saturation level, as the exposure correction processing. In contrast to this example, the exposure correction amount may be the setting of reducing the exposure than the first exposure condition 81 in order to perform the exposure according to the phase-difference detection pixel 41P.

The saturation level is set to a value of an upper limit at which the maximum brightness value of the phase-difference detection pixel 41P in the focus adjustment region 90 is not saturated. For example, in a case where the brightness value is a value of 10 bits (value between 0 and 1023), a value of about 900, which is about 90% of 1023, is set as the saturation level. There are two types of “saturation” state of a state in which a charge that can be accumulated in the pixel 41 is limited and a state in which an increase in the signal component due to an increase in the exposure reaches a plateau and the signal-noise ratio cannot be further improved. In the technology of the present disclosure, the latter case is defined as the “saturation” state.

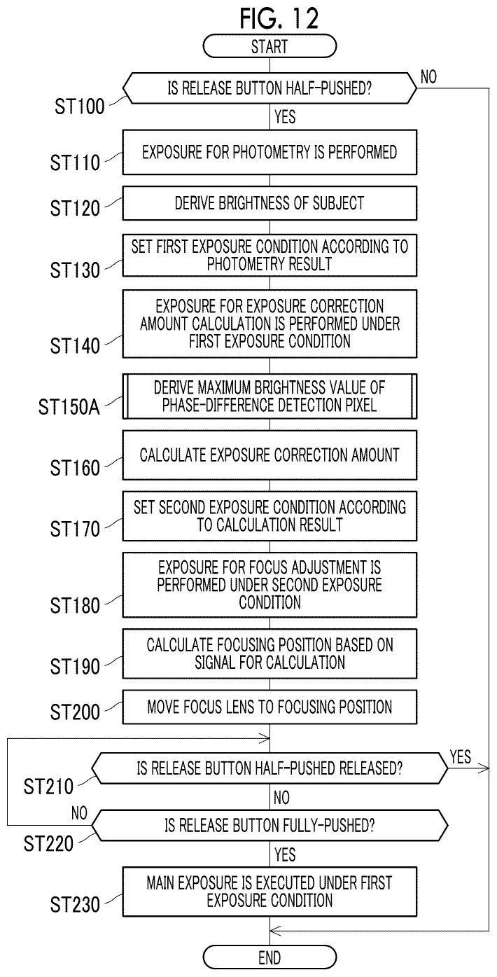

Next, an action of the above configuration will be described with reference to a flowchart shown in FIG. 12 as an example. As shown in FIG. 8, with the start of the operation program 65, the CPU 56 functions as the photometry unit 70, the first exposure condition setting unit 71, the maximum brightness value derivation unit 72, the exposure correction amount calculation unit 73, the second exposure condition setting unit 74, and the focusing calculation unit 75.

In a case where the release button is half-pushed in the static-image capturing mode and the instruction receiving unit 32 receives the instruction to prepare capturing of the static image (YES in step ST100), the exposure for photometry is performed in the imaging element 12 under the control of the controller 20 (step ST110). The signal for image generation 43N obtained in this manner is read out from the image memory 26 to the photometry unit 70. The brightness of the subject is derived in the photometry unit 70 (step ST120). The photometry result 80 of the brightness of the subject is output from the photometry unit 70 to the first exposure condition setting unit 71.

The first exposure condition setting unit 71 sets the first exposure condition 81 according to the photometry result 80 (step ST130). The first exposure condition 81 is output from the first exposure condition setting unit 71 to the stop driving mechanism 19, the imaging element driver 22, and the shutter driving mechanism 24. The exposure for exposure correction amount calculation is performed in the imaging element 12 under the first exposure condition 81 (step ST140).

The signal for image generation 43N obtained in the exposure for exposure correction amount calculation is read out from the image memory 26 to the maximum brightness value derivation unit 72. As shown in FIGS. 9 to 11, the maximum brightness value derivation unit 72 derives the maximum brightness value of the phase-difference detection pixel 41P (step ST150A). The derivation result 82 of the maximum brightness value of the phase-difference detection pixel 41P is output from the maximum brightness value derivation unit 72 to the exposure correction amount calculation unit 73.

As shown in FIG. 11, the exposure correction amount calculation unit 73 calculates, as the exposure correction amount, the difference between the maximum brightness value of the phase-difference detection pixel 41P and the saturation level is calculated (step ST160). The calculation result 83 of the exposure correction amount is output from the exposure correction amount calculation unit 73 to the second exposure condition setting unit 74.

The second exposure condition setting unit 74 sets the second exposure condition 84 according to the calculation result 83 (step ST170). The second exposure condition 84 is output from the second exposure condition setting unit 74 to the stop driving mechanism 19, the imaging element driver 22, and the shutter driving mechanism 24. The exposure for focus adjustment is performed in the imaging element 12 under the second exposure condition 84 (step ST180).

The focusing calculation unit 75 derives the current position of the focus lens 14 on the optical axis OA, based on the drive amount of the motor for focusing from the focus lens driving mechanism 17. Further, the signal for calculation 43P obtained in the exposure for focus adjustment is read out from the image memory 26 to the focusing calculation unit 75. The focusing calculation unit 75 calculates the phase difference α from the signal for calculation 43P of the focus adjustment region 90, and calculates the focusing position of the focus lens 14 based on the phase difference α (step ST190). The calculation result 85 of the focusing position is output from the focusing calculation unit 75 to the focus lens driving mechanism 17. The focus lens driving mechanism 17 moves the focus lens 14 to the focusing position (step ST200).

In a case where the release button is fully pushed and the instruction receiving unit 32 receives the instruction to start capturing of the static image (NO in step ST210, YES in step ST220), the main exposure is executed in the imaging element 12 under the first exposure condition 81 (step ST230). Accordingly, the capturing of one static image is ended.

As described above, the imaging apparatus 10 comprises the controller 20 that is the exposure control device controlling the exposure of the imaging element 12, which includes the normal pixel 41N for imaging the subject and the phase-difference detection pixel 41P for detecting the phase difference α. The CPU 56 of the controller 20 functions as the second exposure condition setting unit 74. The second exposure condition setting unit 74 performs the exposure correction processing according to the difference between the maximum brightness value of the phase-difference detection pixel 41P in the focus adjustment region 90 and the saturation level. Therefore, it is possible to perform the exposure for focus adjustment under the exposure condition (second exposure condition 84) suitable for the phase-difference detection pixel 41P. It is possible to improve the signal-noise ratio of the signal for calculation 43P as compared with a case where the exposure for focus adjustment is performed under the exposure condition (first exposure condition 81) based on the normal pixel 41N. Therefore, it is possible to increase the focusing accuracy.

As shown in FIG. 11, the second exposure condition setting unit 74 calculates the exposure correction amount based on the difference between the maximum brightness value of the phase-difference detection pixel 41P and the saturation level as the exposure correction processing, and performs the exposure to the phase-difference detection pixel 41P (exposure for focus adjustment) based on the exposure correction amount. Therefore, it is possible to maximally improve the signal-noise ratio of the signal for calculation 43P.

In a case where the brightness value of the phase-difference detection pixel 41P and thus the signal for calculation 43P of the phase-difference detection pixel 41P are saturated, the signal component of the signal for calculation 43P is decreased accordingly, and the signal-noise ratio is reduced. In the technology of the present disclosure, as shown in FIG. 11, the saturation level is set to the value of the upper limit at which the maximum brightness value of the phase-difference detection pixel 41P in the focus adjustment region 90 is not saturated. In this manner, it is possible to prevent the reduction in the signal-noise ratio of the signal for calculation 43P due to the saturation.

The phase-difference detection pixel 41P is only the green pixel as described above. Therefore, it is not possible to calculate the brightness value from the signal for calculation 43P, and thus it is not possible to derive the maximum brightness value of the phase-difference detection pixel 41P from the signal for calculation 43P. In the technology of the present disclosure, as shown in FIGS. 9 to 11, the maximum brightness value derivation unit 72 calculates the maximum brightness value of the phase-difference detection pixel 41P, from the maximum brightness value of the normal pixel 41N in the focus adjustment region 90, in a case where the normal pixel 41N images the subject with the set exposure. In this manner, it is possible to derive the maximum brightness value of the phase-difference detection pixel 41P that cannot be derived from the signal for calculation 43P.

As shown in FIG. 9, the maximum brightness value of the normal pixel 41N is obtained by comparing the individual brightness values of the normal pixel 41N in the focus adjustment region 90. Therefore, it is possible to easily obtain the maximum brightness value of the normal pixel 41N.

As shown in FIGS. 9 and 11, the maximum brightness value derivation unit 72 multiplies the maximum brightness value of the normal pixel 41N by the sensitivity ratio SR of the normal pixel 41N and the phase-difference detection pixel 41P to calculate the maximum brightness value of the phase-difference detection pixel 41P. Therefore, it is possible to calculate the maximum brightness value of the phase-difference detection pixel 41P with higher accuracy.

As shown in FIG. 10, the sensitivity ratio SR is changed according to the position of the normal pixel 41NM having the maximum brightness value. Therefore, it is possible to calculate the maximum brightness value of the phase-difference detection pixel 41P with high accuracy, according to the position of the normal pixel 41NM having the maximum brightness value. Further, the sensitivity ratio SR is changed according to the position of the focus adjustment region 90. Therefore, it is possible to calculate the maximum brightness value of the phase-difference detection pixel 41P according to the position of the focus adjustment region 90.

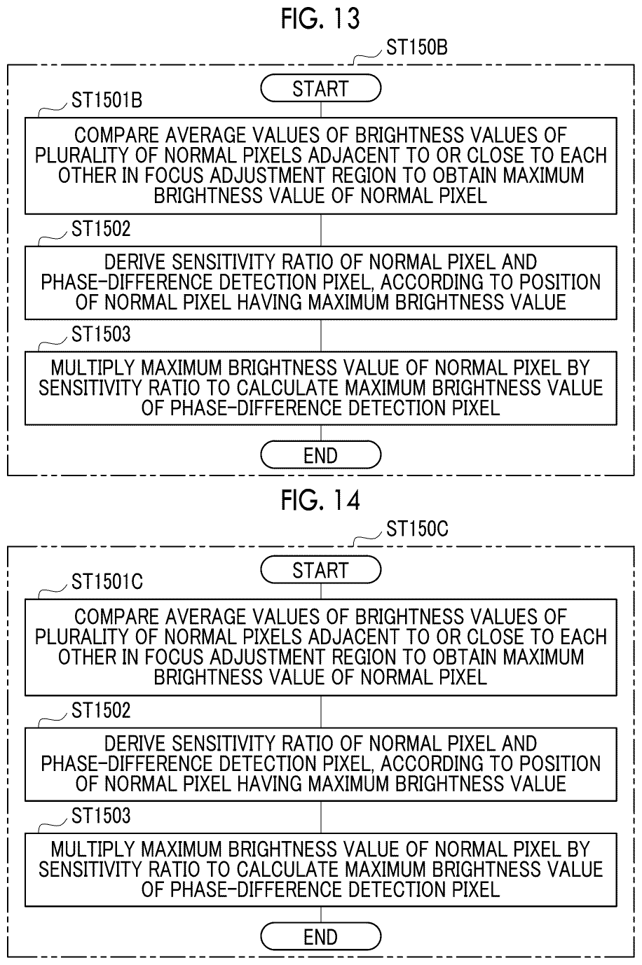

The maximum brightness value of the normal pixel 41N is obtained by comparing the individual brightness values of the normal pixel 41N in the focus adjustment region 90, but the present invention is not limited thereto. As an example, in step ST1501B of step ST150B shown in FIG. 13, the maximum brightness value of the normal pixel 41N may be obtained by comparing the average values of the brightness values of the plurality of normal pixels 41N adjacent to or close to each other in the focus adjustment region 90. Further, as an example, in step ST1501C of step ST150C shown in FIG. 14, the maximum brightness value of the normal pixel 41N may be obtained by comparing the maximum values of the brightness values of the plurality of normal pixels 41N adjacent to or close to each other in the focus adjustment region 90. The processing of step ST150B or ST150C is performed instead of the processing of step ST150A.

In FIGS. 13 and 14, the plurality of adjacent normal pixels 41N are, for example, four normal pixels 41N of 2×2 in row and column, nine normal pixels 41N of 3×3 in row and column, or three normal pixels 41N connected in a row direction. The plurality of adjacent normal pixels 41N are, for example, a plurality of normal pixels 41N positioned at spacings of several pixels, such as five normal pixels 41N at the center, an upper left corner, an upper right corner, a lower left corner, and a lower right corner, of 25 normal pixels 41N of 5×5 in row and column. The plurality of normal pixels 41N adjacent to or close to each other may be configured of normal pixels 41N of a specific color, for example, green pixels having a high degree of contribution to the brightness value. Further, in the case of FIG. 13, the position of the normal pixel 41NM having the maximum brightness value in a case where the sensitivity ratio SR between the normal pixel 41N and the phase-difference detection pixel 41P is derived is the normal pixel 41N at the center of the plurality of normal pixels 41N adjacent to or close to each other.

As described above, the maximum brightness value of the normal pixel 41N may be obtained by comparing any one of the average values of the brightness values of the plurality of normal pixels 41N adjacent to or close to each other in the focus adjustment region 90 or the maximum values of the brightness values of the plurality of normal pixels 41N adjacent to or close to each other in the focus adjustment region 90. Accordingly, it is possible to save time and effort of processing as compared with a case of comparing the brightness value of each of the normal pixels 41N in the focus adjustment region 90.

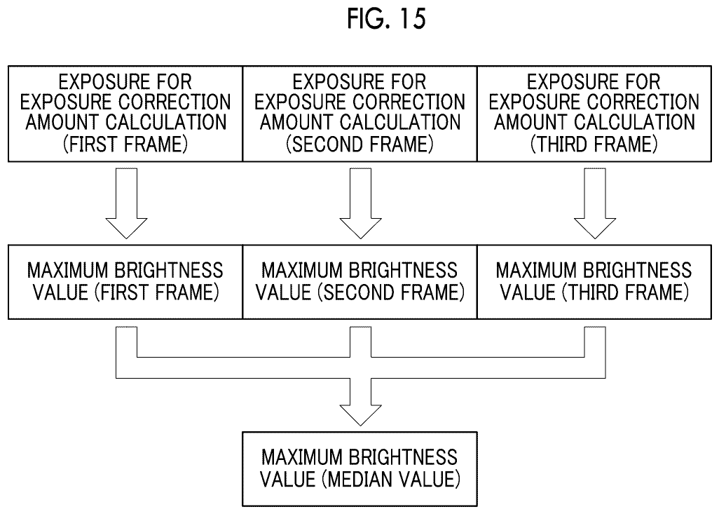

Although the exposure for exposure correction amount calculation is performed only once, the present invention is not limited thereto. As shown in FIG. 15 as an example, the exposure for exposure correction amount calculation may be performed in a plurality of consecutive frames. In this case, the maximum brightness value derivation unit 72 obtains the maximum brightness value of the normal pixel 41N for each of the plurality of consecutive frames. A median value of the plurality of maximum brightness values obtained in this manner is adopted as the maximum brightness value of the normal pixel 41N used in a case where the maximum brightness value of the phase-difference detection pixel 41P is calculated. FIG. 15 shows a case where the exposure for exposure correction amount calculation is performed in three consecutive frames. The median value is a value of which a rank of size is in the middle among the plurality of maximum brightness values. However, in a case where the plurality of maximum brightness values are even, the median value is an arithmetic average value of two maximum brightness values having a median rank. In this manner, it is possible to avoid a situation where an outlier erroneously obtained due to the influence of noise or the like is adopted as the maximum brightness value of the normal pixel 41N used in a case where the maximum brightness value of the phase-difference detection pixel 41P is calculated and the maximum brightness value of the phase-difference detection pixel 41P and thus the exposure correction amount are not correctly calculated.

In order to adopt the median value, at least three consecutive frames are required for the plurality of consecutive frames as exemplified. The plurality of consecutive frames may be four or more frames. However, in a case where the number of frames is increased, a time spent on the exposure for exposure correction amount calculation is increased as well. Thus, the number of frames is preferably about 3 to 5.

### Second Embodiment

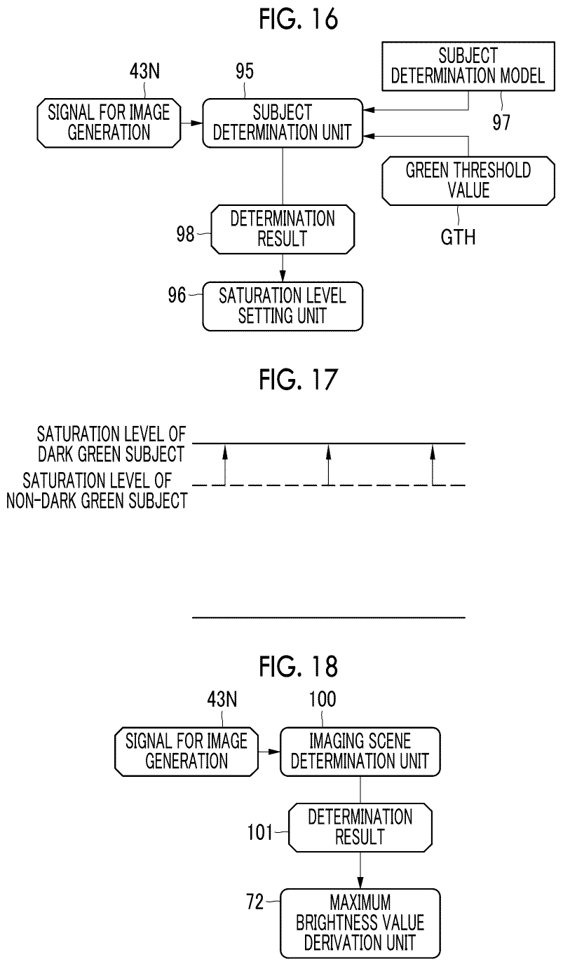

As shown in FIG. 16 as an example, the CPU 56 of a second embodiment functions as a subject determination unit 95 and a saturation level setting unit 96, in addition to each of the processing units 70 to 75 of the first embodiment. The subject determination unit 95 reads out, from the image memory 26, the signal for image generation 43N obtained in the exposure for exposure correction amount calculation. Further, a subject determination model 97 and a green threshold value GTH are input to the subject determination unit 95. The storage 55 stores the subject determination model 97 and the green threshold value GTH. The subject determination model 97 is, for example, a semantic segmentation model that determines a plurality of types of subject classes in units of pixels 41. The subject determination model 97 is an example of “machine learning model” according to the technology of the present disclosure. Further, the green threshold value GTH is an example of “first threshold value” according to the technology of the present disclosure.

The subject determination unit 95 determines the subject class appearing in an image represented by the signal for image generation 43N by using the subject determination model 97. The subject determination unit 95 calculates a ratio of a green subject class among the determined subject classes. The calculated ratio is compared with the green threshold value GTH, and a comparison result is output to the saturation level setting unit 96 as a determination result 98. The ratio of the green subject class is an example of “ratio of subject of specific color” according to the technology of the present disclosure.

The saturation level setting unit 96 sets the saturation level based on the determination result 98. More specifically, as shown in FIG. 17 as an example, in a case where the determination result 98 is that the ratio of the green subject class is less than the green threshold value GTH (hereinafter denoted as non-dark green subject), the saturation level setting unit 96 sets the saturation level to a relatively low saturation level. On the other hand, in a case of the determination result 98 that the ratio of the green subject class is equal to or larger than the green threshold value GTH (hereinafter denoted as dark green subject), the saturation level is set to a saturation level that is relatively higher than the saturation level in a case of the non-dark green subject. The saturation level in the case of the non-dark green subject is set to a value of about 900, which is about 90% of 1023. On the other hand, the saturation level of the dark green subject is set to a value of about 1000, which is about 98% of 1023. The exposure correction amount calculation unit 73 calculates the exposure correction amount based on the saturation level set by the saturation level setting unit 96. Examples of the dark green subject include a forest, a grassland, and moss.

As described above, in the second embodiment, the saturation level is changed according to the subject. Therefore, it is possible to set the saturation level suitable for the subject. Further, in the second embodiment, the saturation level is changed according to the subject class determined by the subject determination model 97. With the subject determination model 97, it is possible to increase the determination accuracy as to whether the subject is the dark green subject or the non-dark green subject.

As described above, the green color filter 46 is disposed in the phase-difference detection pixel 41P. Thus, in the case of the dark green subject, a higher signal for calculation 43P is output than in the case of the non-dark green subject. In the second embodiment, the saturation level is set relatively high in the case of the dark green subject, and thus a higher exposure correction amount is calculated. Accordingly, it is possible to perform the exposure correction processing suitable for the dark green subject.

The determination may be made as to whether the subject is the dark green subject or the non-dark green subject without using the subject determination model 97. For example, an integrated value of the pixel values of the signal for image generation 43N of the green pixel of the normal pixel 41N is calculated, and the calculated integrated value is compared with the green threshold value GTH. In a case where the integrated value is less than the green threshold value GTH, determination is made that the subject is the non-dark green subject. In a case where the integrated value is equal to or larger than the green threshold value GTH, determination is made that the subject is the dark green subject. In this case, the integrated value is an example of “ratio of subject of specific color” according to the technology of the present disclosure.

Although green is exemplified as the specific color, the specific color may be red or blue. However, as described above, since the green color filter 46 is disposed in the phase-difference detection pixel 41P, the specific color is preferably green.

### Third Embodiment

As shown in FIG. 18 as an example, the CPU 56 of a third embodiment functions as an imaging scene determination unit 100, in addition to the processing units 70 to 75 (not shown except for the maximum brightness value derivation unit 72) of the first embodiment. The imaging scene determination unit 100 reads out, from the image memory 26, the signal for image generation 43N obtained in the exposure for exposure correction amount calculation. The imaging scene determination unit 100 performs, for example, light-dark distribution analysis or brightness value histogram analysis of the signal for image generation 43N to determine whether or not an imaging scene is a backlit scene. The imaging scene determination unit 100 outputs, to the maximum brightness value derivation unit 72, a determination result 101 of whether or not the scene is the backlit scene. A machine learning model may be used to determine whether or not the scene is the backlit scene. As the machine learning model, a semantic segmentation model that determines a plurality of types of subjects in the image in units of pixels is preferable to increase determination accuracy of whether or not the scene is the backlit scene.

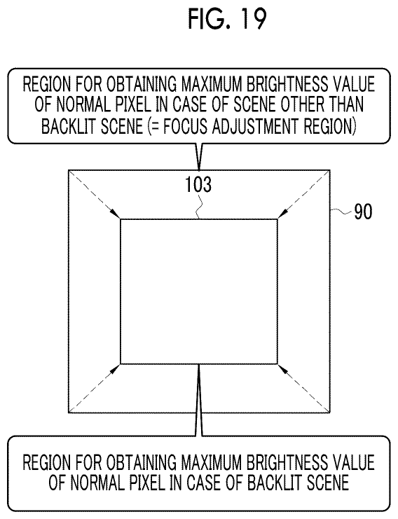

As shown in FIG. 19 as an example, in a case where the determination result 101 of the imaging scene is not the backlit scene, the maximum brightness value derivation unit 72 sets the focus adjustment region 90 as a region for obtaining the maximum brightness value of the normal pixel 41N. On the other hand, in a case where the determination result 98 of the imaging scene is the backlit scene, the maximum brightness value derivation unit 72 sets a reduction region 103 obtained by reducing the focus adjustment region 90 at the predetermined magnification, for example, 0.6 times, as the region for obtaining the maximum brightness value of the normal pixel 41N. The reduction region 103 is an example of “set region” according to the technology of the present disclosure.

In the backlit scene, a center portion is shown dark, and a peripheral portion is shown bright. Further, a main subject to be focused on is often present in the center portion. Thus, in a case where the maximum brightness value of the normal pixel 41N is obtained including the bright peripheral portion, the normal pixel 41N in the peripheral portion in which there is a high possibility that the main subject is not present is set as the normal pixel 41NM having the maximum brightness value, and as a result, an erroneous exposure correction amount is calculated. In a case where the scene is the backlit scene, the maximum brightness value derivation unit 72 changes the region for obtaining the maximum brightness value of the normal pixel 41N. More specifically, in a case where the scene is the backlit scene, the maximum brightness value derivation unit 72 sets the region for obtaining the maximum brightness value of the normal pixel 41N to be narrower than in a case where the scene is not the backlit scene. In this manner, it is possible to prevent the erroneous exposure correction amount from being calculated.

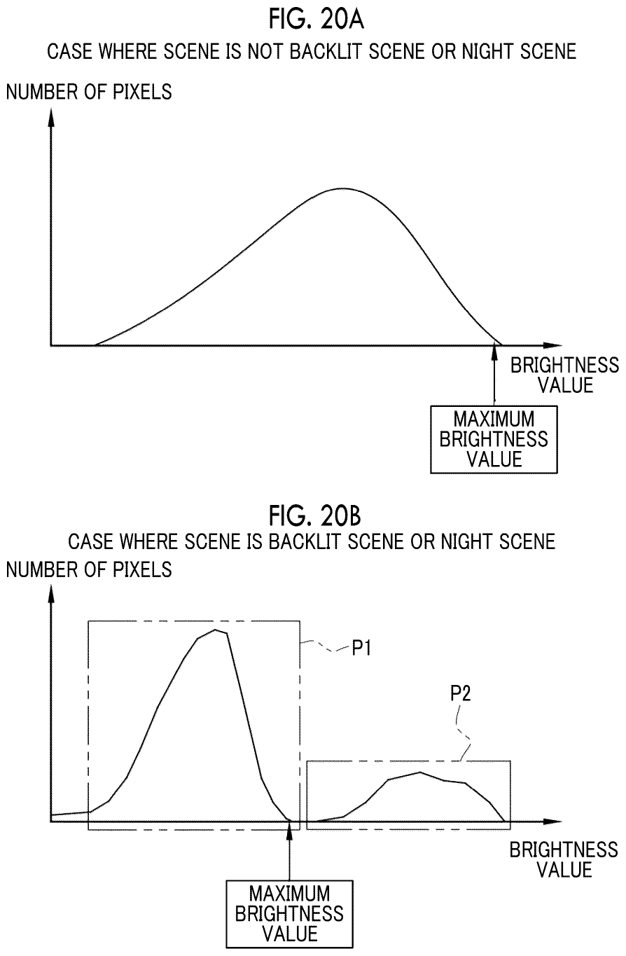

Instead of setting the region for obtaining the maximum brightness value of the normal pixel 41N to be narrow, the maximum brightness value of the normal pixel 41N may be obtained as shown in FIGS. 20A and 20B as an example. In this case, the imaging scene determination unit 100 determines not only whether or not the scene is the backlit scene but also whether or not the scene is the night scene.

The maximum brightness value derivation unit 72 generates a brightness value histogram of the normal pixel 41N in the focus adjustment region 90. As shown in FIG. 20A, in a case where there is one peak in the distribution of the brightness values of the normal pixels 41N in the focus adjustment region 90 or in a case where there is one inflection point in the distribution, the imaging scene determination unit 100 outputs the determination result 101 indicating that the scene is not the backlit scene or the night scene. In this case, the maximum brightness value derivation unit 72 employs the maximum brightness value literally in the brightness value histogram, as the maximum brightness value of the normal pixel 41N used in a case of calculating the maximum brightness value of the phase-difference detection pixel 41P. On the other hand, as shown in FIG. 20B, in a case where there are two peaks of the distribution of the brightness values of the normal pixels 41N in the focus adjustment region 90 or in a case where there are a plurality of inflection points of the distribution, the imaging scene determination unit 100 outputs the determination result 101 indicating that the scene is the backlit scene or the night scene. In this case, the maximum brightness value derivation unit 72 employs the maximum brightness value at a peak P1 on a low brightness side among peaks P1 and P2 of the distribution of the two brightness values of the brightness value histogram, as the maximum brightness value of the normal pixel 41N used in a case of calculating the maximum brightness value of the phase-difference detection pixel 41P.

The peak P1 on the low brightness side is a portion that is relatively dark in the backlit scene or the night scene. Therefore, in a case where there are two peaks of the distribution of the brightness values of the normal pixels 41N in the focus adjustment region 90 or there are the plurality of inflection points of the distribution, that is, in a case where the scene is the backlit scene or the night scene, with the employment of the maximum brightness value at the peak P1 on the low brightness side, it is possible to prevent the erroneous exposure correction amount from being calculated, as in a case where the region for obtaining the maximum brightness value of the normal pixel 41N is set to be narrow.

### Fourth Embodiment

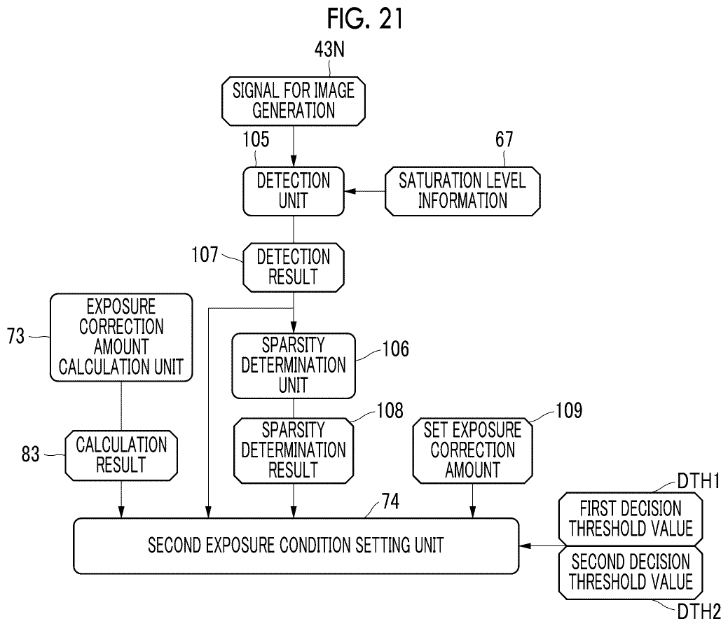

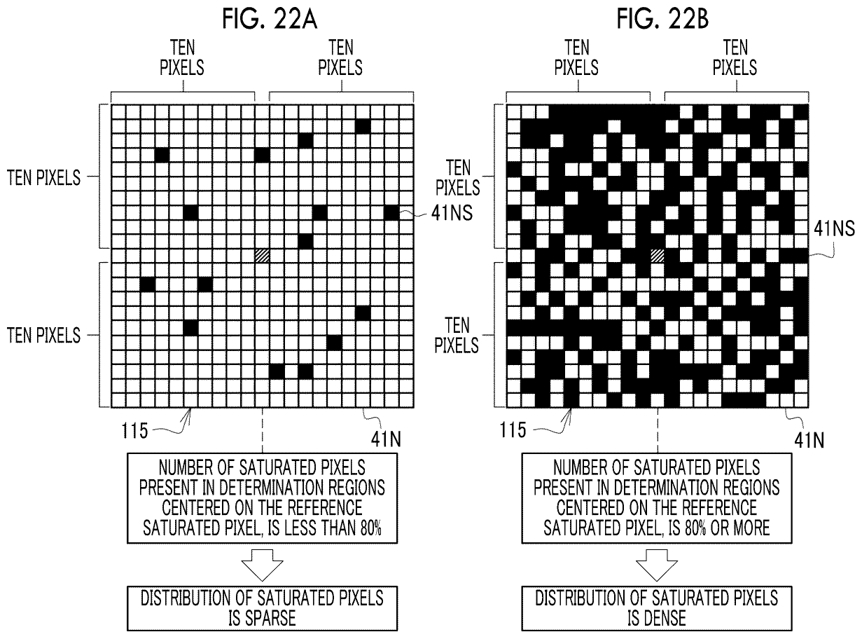

As shown in FIG. 21 as an example, the CPU 56 of a fourth embodiment functions as a detection unit 105 and a sparsity determination unit 106, in addition to the processing units 70 to 75 (not shown except for the exposure correction amount calculation unit 73 and the second exposure condition setting unit 74) of the first embodiment. The detection unit 105 reads out, from the image memory 26, the signal for image generation 43N obtained in the exposure for exposure correction amount calculation. Further, the saturation level information 67 is input to the detection unit 105. The detection unit 105 calculates the brightness value from the signal for image generation 43N. With the comparison of the calculated brightness value with the saturation level, the normal pixel 41N (hereinafter denoted as saturated pixel 41NS (refer to FIGS. 22A and 22B)) that has reached the saturation level in the focus adjustment region 90 is detected. The detection unit 105 outputs a detection result 107 of the saturated pixel 41NS to the sparsity determination unit 106 and the second exposure condition setting unit 74.

The sparsity determination unit 106 determines whether the distribution of the saturated pixels 41NS is sparse or dense based on the detection result 107. Further, in a case where determination is made that the distribution of the saturated pixels 41NS is dense, the sparsity determination unit 106 obtains a ratio of the saturated pixels 41NS for which the distribution is determined to be dense. The ratio is obtained by dividing the number of the saturated pixels 41NS determined to have a dense distribution by the number of all the normal pixels 41N in the focus adjustment region 90. The sparsity determination unit 106 outputs, to the second exposure condition setting unit 74, a sparsity determination result 108 indicating whether the distribution of the saturated pixels 41NS is sparse or dense. In a case where the distribution of the saturated pixels 41NS is determined to be dense, the sparsity determination result 108 also includes the ratio of the saturated pixels 41NS determined to be dense.

Specifically, the determination of whether the distribution of the saturated pixels 41NS is sparse or dense is performed as follows. That is, as shown in FIGS. 22A and 22B as an example, the sparsity determination unit 106 first sets a determination region 115 centered on the reference saturated pixel 41NS indicated by thin hatching. The determination region 115 is a rectangular region having a width of 10 pixels in up, down, left, and right directions from the reference saturated pixel 41NS. The sparsity determination unit 106 obtains the ratio of the saturated pixels 41NS present in the determination region 115. The sparsity determination unit 106 sets the determination region 115 with all the saturated pixels 41NS as the reference saturated pixels 41NS, and obtains the ratio of the saturated pixels 41NS for all the determination regions 115. Then, as shown in FIG. 22A, in a case where the number of the saturated pixels 41NS present in all the determination regions 115 is less than 80%, the distribution of the saturated pixels 41NS is determined to be sparse. On the other hand, as shown in FIG. 22B, in a case where there is at least one determination region 115 in which the number of saturated pixels 41NS is 80% or more, the distribution of the saturated pixels 41NS is determined to be dense.

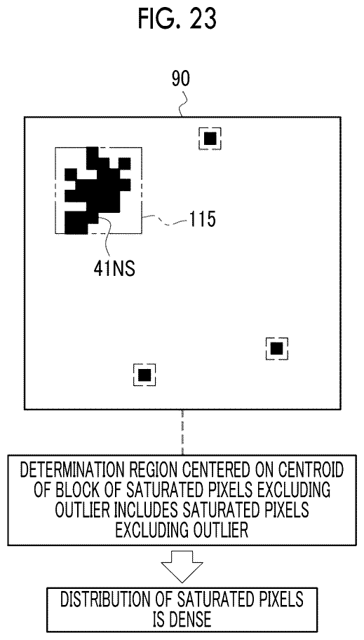

Alternatively, as shown in FIG. 23 as an example, the sparsity determination unit 106 first derives an outlier (saturated pixel 41NS surrounded by broken line) that is threshold value distance away from the other saturated pixel 41NS. The determination region 115 centered on a centroid of a block of the saturated pixels 41NS excluding the outlier is set. In a case where all the saturated pixels 41NS excluding the outlier are included in the determination region 115, the sparsity determination unit 106 determines that the distribution of the saturated pixels 41NS is dense. In a case other than the above, the sparsity determination unit 106 determines that the distribution of the saturated pixels 41NS is sparse.

Returning to FIG. 21, a set exposure correction amount 109, a first decision threshold value DTH1, and a second decision threshold value DTH2 are input to the second exposure condition setting unit 74, in addition to the calculation result 83 from the exposure correction amount calculation unit 73 and the sparsity determination result 108 from the sparsity determination unit 106. The storage 55 stores the set exposure correction amount 109, the first decision threshold value DTH1, and the second decision threshold value DTH2. The first decision threshold value DTH1 is an example of “second threshold value” according to the technology of the present disclosure. Further, the second decision threshold value DTH2 is an example of “third threshold value” according to the technology of the present disclosure.

The second exposure condition setting unit 74 obtains the ratio of the saturated pixels 41NS based on the detection result 107. The ratio is obtained by dividing the number of the saturated pixels 41NS by the number of all the normal pixels 41N in the focus adjustment region 90. The second exposure condition setting unit 74 compares the ratio of the saturated pixels 41NS with the first decision threshold value DTH1. In a case where the ratio of the saturated pixels 41NS is equal to or less than the first decision threshold value DTH1, the second exposure condition setting unit 74 sets the second exposure condition 84 according to the calculation result 83 (calculated exposure correction amount). Further, even in a case where the sparsity determination unit 106 determines that the ratio of the saturated pixel 41NS is larger than the first decision threshold value DTH1 and the distribution of the saturated pixel 41NS is sparse, the second exposure condition setting unit 74 sets the second exposure condition 84 according to the calculation result 83. In other words, the setting of the second exposure condition 84 according to the calculation result 83 means performing the exposure correction processing according to the difference between the maximum brightness value of the phase-difference detection pixel 41P and the saturation level. For example, 1% is set as the first decision threshold value DTH1.

In a case where the sparsity determination unit 106 determines that the ratio of the saturated pixels 41NS is larger than the first decision threshold value DTH1 and the distribution of the saturated pixels 41NS is dense, the second exposure condition setting unit 74 compares the ratio of the saturated pixels 41NS determined to be dense with the second decision threshold value DTH2. In a case where the ratio of the saturated pixel 41NS determined to have the dense distribution is less than the second decision threshold value DTH2, the second exposure condition setting unit 74 sets the second exposure condition 84 according to the set exposure correction amount 109. In other words, the setting of the second exposure condition 84 according to the set exposure correction amount 109 means performing the exposure correction processing according to the set exposure correction amount 109.

The set exposure correction amount 109 is +0.5 exposure value (EV) to +1.0 EV. The set exposure correction amount 109 may be switched according to the situation, such as setting the set exposure correction amount 109 to +0.5 EV in a case where a time of the exposure for focus adjustment is desired to be shortened, such as a case of the quick imaging, a case of the continuous capturing mode, or a case of moving object tracking auto focus (AF), and setting the set exposure correction amount 109 to +1.0 EV in other cases.

In a case where the ratio of the saturated pixels 41NS determined to have the dense distribution is equal to or larger than the second decision threshold value DTH2, the second exposure condition setting unit 74 does not set the second exposure condition 84 according to the calculation result 83 and does not set the second exposure condition 84 according to the set exposure correction amount 109, and sets the first exposure condition 81 as it is as the second exposure condition 84. That is, the second exposure condition setting unit 74 does not perform the exposure correction processing.

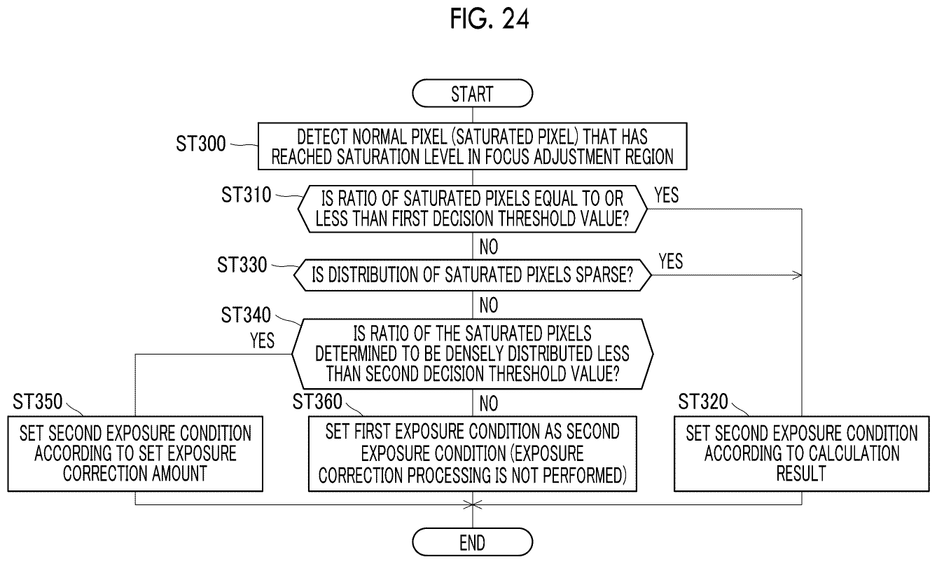

A flowchart shown in FIG. 24 as an example is a processing procedure of the fourth embodiment. First, the signal for image generation 43N obtained in the exposure for exposure correction amount calculation is read out from the image memory 26 to the detection unit 105. The detection unit 105 detects the normal pixel 41N that has reached the saturation level in the focus adjustment region 90, that is, the saturated pixel 41NS (step ST300). The detection result 107 of the saturated pixel 41NS is output from the detection unit 105 to the sparsity determination unit 106 and the second exposure condition setting unit 74.

In the second exposure condition setting unit 74, the ratio of the saturated pixels 41NS is compared with the first decision threshold value DTH1 (step ST310). In a case where the ratio of the saturated pixels 41NS is equal to or less than the first decision threshold value DTH1 (YES in step ST310), the second exposure condition setting unit 74 sets the second exposure condition 84 according to the calculation result 83 (step ST320). On the other hand, in a case where the ratio of the saturated pixels 41NS is larger than the first decision threshold value DTH1 (NO in step ST310), the processing proceeds to step ST330.

In step ST330, the sparsity determination unit 106 determines whether the distribution of the saturated pixels 41NS is sparse or dense. In a case where the distribution of the saturated pixels 41NS is determined to be sparse (YES in step ST330), the second exposure condition setting unit 74 sets the second exposure condition 84 according to the calculation result 83, as in a case where the ratio of the saturated pixels 41NS is equal to or less than the first decision threshold value DTH1 (step ST320). On the other hand, in a case where the distribution of the saturated pixels 41NS is determined to be dense (NO in step ST330), the processing proceeds to step ST340.

In step ST340, the second exposure condition setting unit 74 compares the ratio of the saturated pixel 41NS determined to have the dense distribution with the second decision threshold value DTH2. In a case where the ratio of the saturated pixels 41NS determined to be densely distributed is less than the second decision threshold value DTH2 (YES in step ST340), the second exposure condition setting unit 74 sets the second exposure condition 84 according to the set exposure correction amount 109 (step ST350). On the other hand, in a case where the ratio of the saturated pixels 41NS determined to have the dense distribution is equal to or larger than the second decision threshold value DTH2 (NO in step ST340), the second exposure condition setting unit 74 sets the first exposure condition 81 as the second exposure condition 84 (step ST360). That is, in this case, the exposure correction processing is not performed.

As described above, in the fourth embodiment, the detection unit 105 detects the saturated pixel 41NS in the focus adjustment region 90. In a case where the ratio of the saturated pixels 41NS is equal to or less than the first decision threshold value DTH1, the second exposure condition setting unit 74 performs the exposure correction processing according to the difference between the maximum brightness value of the phase-difference detection pixel 41P and the saturation level. Therefore, in a case where the ratio of the saturated pixels 41NS is equal to or less than the first decision threshold value DTH1, it is possible to increase the focusing accuracy.

Further, the sparsity determination unit 106 determines whether the distribution of the saturated pixels is sparse or dense. In a case where the ratio of the saturated pixels 41NS is larger than the first decision threshold value DTH1 and the sparsity determination unit 106 determines that the distribution is sparse, the second exposure condition setting unit 74 performs the exposure correction processing according to the difference between the maximum brightness value of the phase-difference detection pixel 41P and the saturation level. Therefore, in a case where the ratio of the saturated pixels 41NS is larger than the first decision threshold value DTH1 and the sparsity determination unit 106 determines that the distribution is sparse, it is possible to increase the focusing accuracy.

The exposure correction processing is performed according to the difference between the maximum brightness value of the phase-difference detection pixel 41P and the saturation level, in a case where the ratio of the saturated pixels 41NS is larger than the first decision threshold value DTH1 and the distribution is dense, the sparsity determination unit 106 determines that the distribution is dense, and the ratio of the saturated pixels 41NS determined to be dense is less than the second decision threshold value DTH2, there is a concern that the signal for calculation 43P of the phase-difference detection pixel 41P in the focus adjustment region 90 may exceed the saturation level. In a case where the signal for calculation 43P exceeds the saturation level, the signal component exceeding the saturation level is lost, and thus the signal noise ratio of the signal for calculation 43P is decreased. The second exposure condition setting unit 74 performs the exposure correction processing according to the set exposure correction amount 109 set in advance. In this manner, it is possible to avoid the saturation level of the signal for calculation 43P of the phase-difference detection pixel 41P in the focus adjustment region 90 being exceeded. It is possible to prevent deterioration of the focusing accuracy.

Further, the exposure correction processing is performed according to the difference between the maximum brightness value of the phase-difference detection pixel 41P and the saturation level or the exposure correction processing according to the set exposure correction amount 109 is performed, in a case where the ratio of the saturated pixels 41NS is larger than the first decision threshold value DTH1 and the distribution is dense, the sparsity determination unit 106 determines that the distribution is dense, and the ratio of the saturated pixels 41NS determined to be dense is equal to or larger than the second decision threshold value DTH2, there is a concern that most of the signal for calculation 43P of the phase-difference detection pixels 41P in the focus adjustment region 90 may exceed the saturation level. The second exposure condition setting unit 74 does not perform the exposure correction processing. In this manner, it is possible to avoid the saturation level of the signal for calculation 43P of the phase-difference detection pixel 41P in the focus adjustment region 90 being exceeded. It is possible to prevent deterioration of the focusing accuracy.

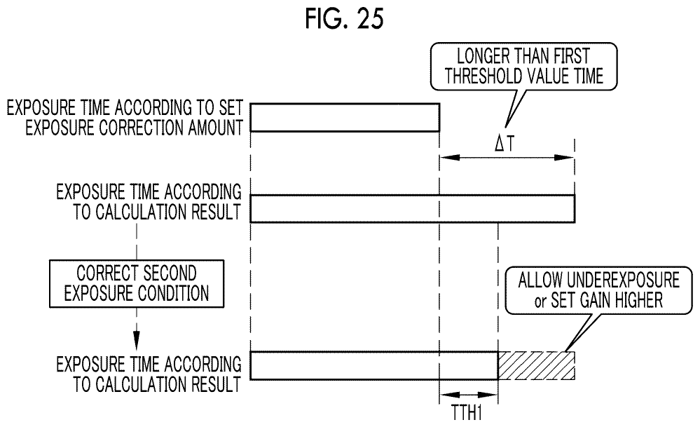

As shown in FIG. 25 as an example, a case is considered where the second exposure condition 84 according to the calculation result 83 is set and the exposure for focus adjustment is performed. In this case, the second exposure condition setting unit 74 obtains a difference ΔT between a time (hereinafter denoted as exposure time according to the calculation result 83) required for the exposure for focus adjustment in a case where the second exposure condition 84 is set according to the calculation result 83, and a time (hereinafter denoted as exposure time according to the set exposure correction amount 109) required for the exposure for focus adjustment in a case where the second exposure condition 84 is set according to the set exposure correction amount 109. The difference ΔT is compared with a first threshold value time TTH1 set in advance. The storage 55 stores the first threshold value time TTH1. A time, for example, 0.5 seconds, at which the user feels a processing delay is set as the first threshold value time TTH1. In this case, a time obtained by adding the exposure time according to the set exposure correction amount 109 and the first threshold value time TTH1 is an example of “threshold value time set in advance” according to the technology of the present disclosure.

In a case where the difference ΔT is longer than the first threshold value time TTH1, the second exposure condition setting unit 74 corrects the second exposure condition 84 such that the difference ΔT is equal to or less than the first threshold value time TTH1. That is, in a case where the difference ΔT is longer than the first threshold value time TTH1, the exposure time is rounded up to be shorter according to the calculation result 83, and underexposure is allowed for the phase-difference detection pixel 41P. Alternatively, the gain applied to the image signal 43 may be set to be high to compensate for the underexposure. However, since the noise component increases in a case where the gain is set to be excessively high, it is preferable to set an upper limit for the gain setting. As described above, in a case where the difference ΔT is longer than the first threshold value time TTH1, the second exposure condition 84 is corrected such that the difference ΔT is equal to or less than the first threshold value time TTH1, and thus it is possible to reduce a concern that the user may feel the processing delay.

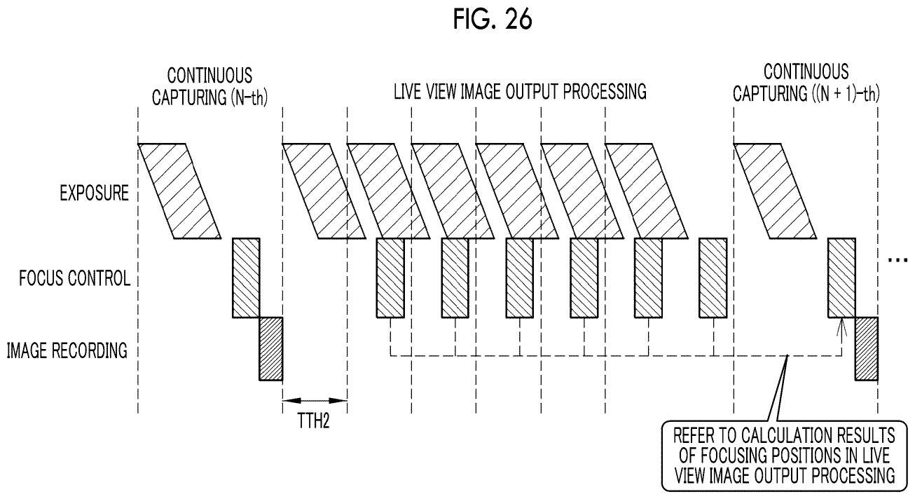

As shown in FIG. 26 as an example, in the continuous capturing mode, a case where live view image output processing is performed between the image recording pertaining to N-th (N is a natural number of 1 or more) continuous capturing and the image recording pertaining to (N 30 1)-th continuous capturing is considered. The live view image output processing is processing of repeating the exposure for focus adjustment and the focus control a predetermined number of times (six times in FIG. 26) without performing the image recording. The focus control of the live view image output processing is control of calculating the focusing position of the focus lens 14 from the signal for calculation 43P obtained in the exposure for focus adjustment. However, in the focus control of the live view image output processing, the movement of the focus lens 14 to the focusing position is not performed.

In the N+1th continuous capturing focus control, the focusing calculation unit 75 calculates the focusing position with reference to the calculation results 85 of the plurality of focusing positions obtained in the focus control of the live view image output processing after the Nth continuous capturing. In other words, the focusing calculation unit 75 predicts a current focusing position from the calculation results 85 of most recent plurality of focusing positions. The focus lens driving mechanism 17 moves the focus lens 14 to the focusing position predicted by the focusing calculation unit 75.

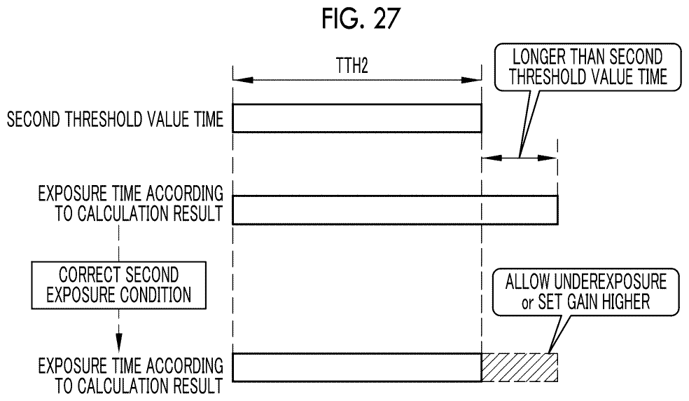

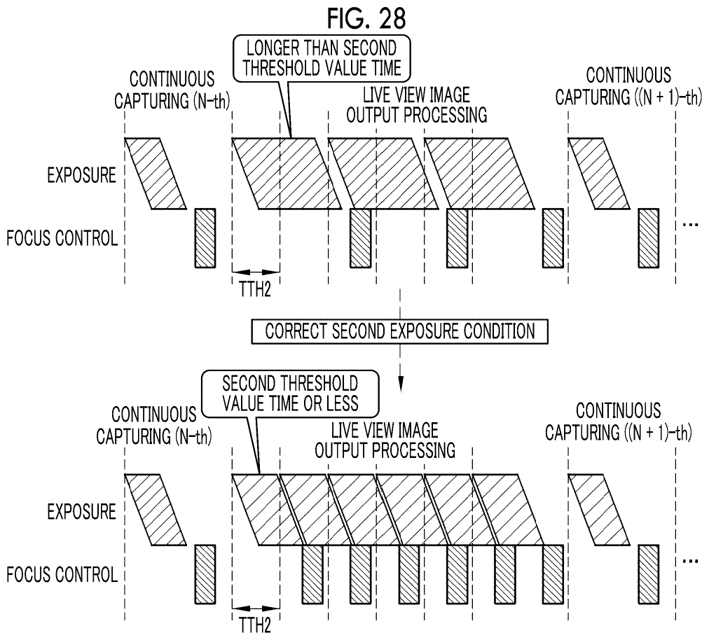

As shown in FIGS. 27 and 28 as an example, in the focus control of the live view image output processing, a case is considered where the second exposure condition 84 is set according to the calculation result 83 to perform the exposure for focus adjustment. In this case, the second exposure condition setting unit 74 compares the exposure time according to the calculation result 83 with the second threshold value time TTH2 set in advance. The storage 55 stores the second threshold value time TTH2. The second threshold value time TTH2 is the longest exposure time of the imaging element 12 that may be set in one frame of the live view image output processing. The second threshold value time TTH2 is an example of “threshold value time set in advance” according to the technology of the present disclosure.

In a case where the exposure time according to the calculation result 83 is longer than the second threshold value time TTH2, the second exposure condition setting unit 74 corrects the second exposure condition 84 such that the exposure time according to the calculation result 83 is equal to or less than the second threshold value time TTH2. That is, in a case where the exposure time according to the calculation result 83 is longer than the second threshold value time TTH2, the exposure time according to the calculation result 83 is rounded up to be shorter as in the case of FIG. 25, and the underexposure the phase-difference detection pixel 41P is allowed. Alternatively, the gain applied to the image signal 43 may be set to be high to compensate for the underexposure. However, since the noise component increases in a case where the gain is set to be excessively high, it is preferable to set an upper limit for the gain setting.

As described above, in a case where the exposure time according to the calculation result 83 is longer than the second threshold value time TTH2, the second exposure condition 84 is corrected such that the exposure time according to the calculation result 83 is equal to or less than the second threshold value time TTH2. Therefore, it is possible to include the exposure time according to the calculation result 83, in the longest exposure time of the imaging element 12 that may be set in one frame of the live view image output processing. Therefore, as shown in FIG. 28, before the second exposure condition 84 is corrected, three calculation results 85 are obtained in the live view image output processing. On the other hand, after the second exposure condition 84 is corrected, the number of calculation results 85 obtained in the live view image output processing is doubled to six. Since the number of calculation results 85 that can be used for predicting the focusing position increases, it is possible to improve the prediction accuracy of the focusing position in the focus control of the (N+1)-th continuous capturing. In FIG. 28, an image recording portion is not shown.

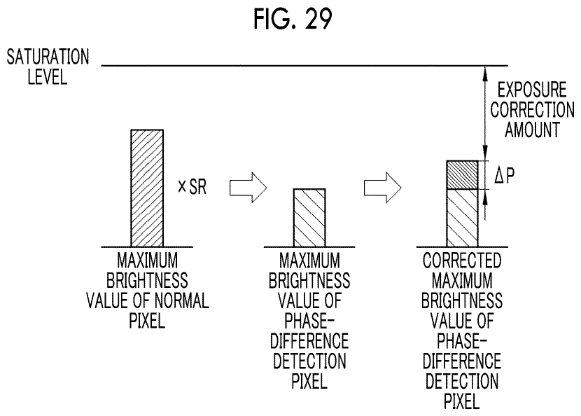

In the first embodiment, the example is illustrated in which the normal pixel 41N is used for photometry based on the signal for image generation 43N of the plurality of normal pixels 41N for photometry that are equally dispersed on the imaging surface 42. However, the present invention is not limited thereto. The photometry by the phase-difference detection pixel 41P based on the signal for calculation 43P of the phase-difference detection pixel 41P for photometry in the focus adjustment region 90 may be performed. However, in this case, as shown in FIG. 29 as an example, the maximum brightness value of the phase-difference detection pixel 41P is corrected by adding a difference ΔP between the brightness of the subject derived by the photometry of the phase-difference detection pixel 41P and the brightness of the subject derived by the photometry by the normal pixel 41N to the maximum brightness value of the phase-difference detection pixel 41P obtained by multiplying the maximum brightness value of the normal pixel 41N by the sensitivity ratio SR. The exposure correction amount calculation unit 73 calculates the difference between the corrected maximum brightness value of the phase-difference detection pixel 41P and the saturation level, as the exposure correction amount.

The exposure may be controlled by an electronic shutter instead of the shutter 23.

The imaging apparatus according to the technology of the present disclosure is not limited to the exemplified mirrorless single-lens digital camera, and may be a compact digital camera, a video camera, a surveillance camera, a smartphone, a tablet terminal, or an endoscope.

Further, the signal for calculation 43P of the phase-difference detection pixel 41P obtained by the exposure control device according to the technology of the present disclosure is not limited to the use in the focus control device in the example. For example, the present invention can also be used for creation of a distance map representing a distance from the imaging apparatus to the subject, generation of a three-dimensional image using information on the phase difference α, and the like.

In each of the above embodiments, for example, the following various processors can be used as a hardware structure of processing units that execute various types of processing, such as the image processing unit 27, the display controller 30, the instruction receiving unit 32, the photometry unit 70, the first exposure condition setting unit 71, the maximum brightness value derivation unit 72, the exposure correction amount calculation unit 73, the second exposure condition setting unit 74, the focusing calculation unit 75, the subject determination unit 95, the saturation level setting unit 96, the imaging scene determination unit 100, the detection unit 105, and the sparsity determination unit 106. The various processors include, for example, the CPU 56 which is a general-purpose processor executing software (operation program 65) to function as various processing units, a programmable logic device (PLD), such as a field programmable gate array (FPGA), which is a processor whose circuit configuration can be changed after manufacture, and/or a dedicated electric circuit, such as an application specific integrated circuit (ASIC), which is a processor having a dedicated circuit configuration designed to perform specific processing.

One processing unit may be configured by one of the various types of processors or may be configured by a combination of two or more processors of the same type or different types (for example, a combination of a plurality of FPGAs and/or a combination of a CPU and an FPGA). Further, a plurality of processing units may be configured by one processor.

As an example of configuring the plurality of processing units with one processor, first, there is a form in which one processor is configured by a combination of one or more CPUs and software and the processor functions as the plurality of processing units, as represented by computers such as a client and a server. Second, there is a form in which a processor that realizes the functions of the entire system including the plurality of processing units with one integrated circuit (IC) chip is used, as represented by a system-on-chip (SoC) or the like. In this manner, various processing units are configured by using one or more of the above-described various processors as hardware structures.

More specifically, a circuitry combining circuit elements such as semiconductor elements can be used as the hardware structure of the various processors.

It is possible to understand the techniques described in the following Supplementary Notes from the above description.

### Supplementary Note 1

An exposure control device that controls exposure of an imaging element including a normal pixel for imaging a subject and a phase-difference detection pixel for detecting a phase difference, the exposure control device comprising a processor, wherein the processor is configured to perform exposure correction processing according to a difference between a maximum brightness value of the phase-difference detection pixel in a set region and a saturation level.

### Supplementary Note 2

The exposure control device according to Supplementary Note 1, wherein the processor is configured to calculate an exposure correction amount based on the difference, as the exposure correction processing, and perform the exposure to the phase-difference detection pixel based on the exposure correction amount.

### Supplementary Note 3

The exposure control device according to Supplementary Note 1 or 2, wherein the saturation level is set to a value of an upper limit at which the maximum brightness value of the phase-difference detection pixel in the set region is not saturated.

### Supplementary Note 4

The exposure control device according to any one of Supplementary Notes 1 to 3, wherein the processor is configured to change the saturation level according to the subject.

### Supplementary Note 5

The exposure control device according to Supplementary Note 4, wherein the processor is configured to change the saturation level according to a subject class determined by a machine learning model.

### Supplementary Note 6

The exposure control device according to Supplementary Note 4, wherein a filter of a specific color is disposed in the phase-difference detection pixel, and the processor is configured to set, in a case where a ratio of the subject of the specific color is equal to or greater than a first threshold value set in advance, the saturation level higher than in a case where the ratio of the subject of the specific color is less than the first threshold value.

### Supplementary Note 7

The exposure control device according to any one of Supplementary Notes 1 to 6, wherein the processor is configured to calculate the maximum brightness value of the phase-difference detection pixel from a maximum brightness value of the normal pixel in the set region in a case where the subject is imaged with the normal pixel at a set exposure.

### Supplementary Note 8

The exposure control device according to Supplementary Note 7, wherein the maximum brightness value of the normal pixel is obtained by comparing any one of individual brightness values of the normal pixel in the set region, average values of the brightness values of a plurality of the normal pixels that are adjacent to or close to each other in the set region, or maximum values of the brightness values of the plurality of the normal pixels that are adjacent to or close to each other in the set region.

### Supplementary Note 9

The exposure control device according to Supplementary Note 7 or 8, wherein the processor is configured to calculate the maximum brightness value of the phase-difference detection pixel by multiplying a sensitivity ratio between the normal pixel and the phase-difference detection pixel by the maximum brightness value of the normal pixel.

### Supplementary Note 10

The exposure control device according to Supplementary Note 9, wherein the sensitivity ratio is changed according to a position of the normal pixel having the maximum brightness value.

### Supplementary Note 11

The exposure control device according to Supplementary Note 9 or 10, wherein the sensitivity ratio is changed according to a position of the set region.

### Supplementary Note 12

The exposure control device according to any one of Supplementary Notes 7 to 11, wherein the processor is configured to change the set region in a case of a backlit scene.

### Supplementary Note 13

The exposure control device according to Supplementary Note 12, wherein the processor is configured to set, in a case of the backlit scene, the set region to be narrower than in a case of a scene other than the backlit scene.

### Supplementary Note 14

The exposure control device according to any one of Supplementary Notes 7 to 13, wherein the processor is configured to, in a case where there are two peaks of a distribution of brightness values of the normal pixels in the set region or in a case where there are a plurality of inflection points of the distribution, employ a maximum brightness value at a peak on a low brightness side among the peaks of the distribution as the maximum brightness value of the normal pixel used in a case of calculating the maximum brightness value of the phase-difference detection pixel.

### Supplementary Note 15

The exposure control device according to Supplementary Note 14, wherein the processor is configured to, in a case of a backlit scene or a night scene, employ the maximum brightness value at the peak on the low brightness side as the maximum brightness value of the normal pixel used in a case of calculating the maximum brightness value of the phase-difference detection pixel.

### Supplementary Note 16

The exposure control device according to any one of Supplementary Notes 7 to 15, wherein the processor is configured to employ a median value of the maximum brightness values of the normal pixels obtained in a plurality of consecutive frames as the maximum brightness value of the normal pixel used in a case of calculating the maximum brightness value of the phase-difference detection pixel.

### Supplementary Note 17

The exposure control device according to any one of Supplementary Notes 1 to 16, wherein the processor is configured to detect the normal pixels that have reached the saturation level in the set region, and in a case where a ratio of the normal pixels that have reached the saturation level is equal to or less than a second threshold value set in advance, perform exposure correction processing according to the difference.

### Supplementary Note 18

The exposure control device according to Supplementary Note 17, wherein the processor is configured to determine whether a distribution of the normal pixels that have reached the saturation level is sparse or dense, perform the exposure correction processing according to the difference in a case where the ratio is determined to be larger than the second threshold value and the distribution is determined to be sparse, perform the exposure correction processing according to a set exposure correction amount set in advance in a case where the ratio is determined to be larger than the second threshold value, the distribution is determined to be dense, and the ratio of the normal pixels in which the distribution is determined to be dense is less than a third threshold value set in advance, and not perform the exposure correction processing in a case where the ratio is determined to be larger than the second threshold value, the distribution is determined to be dense, and the ratio of the normal pixels in which the distribution is determined to be dense is equal to or larger than the third threshold value.

### Supplementary Note 19

The exposure control device according to any one of Supplementary Notes 1 to 18, wherein the processor is configured to calculate, as the exposure correction processing, an exposure correction amount based on the difference, perform the exposure to the phase-difference detection pixel based on the exposure correction amount, and in a case where an exposure time of an exposure condition according to the exposure correction amount is longer than a threshold value time set in advance, correct the exposure condition such that the exposure time is equal to or less than the threshold value time.

### Supplementary Note 20

The exposure control device according to any one of Supplementary Notes 1 to 19, wherein the processor is configured to calculate, as the exposure correction processing, an exposure correction amount based on the difference, perform exposure to the phase-difference detection pixel based on the exposure correction amount, and, in continuous capturing in which the exposure to the phase-difference detection pixel is performed during image recording, and in a case where an exposure time of an exposure condition according to the exposure correction amount is longer than a threshold value time set in advance, correct the exposure condition such that the exposure time is equal to or less than the threshold value time.

### Supplementary Note 21

A focus control device comprising the exposure control device according to any one of Supplementary Notes 1 to 20.

### Supplementary Note 22

An imaging apparatus comprising the exposure control device according to any one of Supplementary Notes 1 to 20.

In the technology of the present disclosure, the above-described various embodiments and/or various modification examples can be appropriately combined. It is needless to say that the technique of the present disclosure is not limited to each of the embodiments described above and various configurations can be employed without departing from the gist. Furthermore, the technology of the present disclosure extends to a storage medium that non-transitorily stores a program in addition to the program.

The contents described and shown above are detailed descriptions of portions according to the technology of the present disclosure and are merely examples of the technology of the present disclosure. For example, the above description of the configurations, functions, actions, and effects is an example of the configurations, functions, actions, and effects of the portions according to the technology of the present disclosure. Therefore, it is needless to say that an unnecessary part may be deleted, a new element may be added, or a replacement may be performed to the description content and the illustrated content described above within a scope not departing from the gist of the technique of the present disclosure. Further, in order to avoid complication and facilitate understanding of portions according to the technology of the present disclosure, description related to common technical knowledge or the like that does not need to be particularly described for enabling implementation of the technology of the present disclosure is omitted in the contents described and shown above.

In the present specification, “A and/or B” has the same meaning as “at least one of A or B”. That is, “A and/or B” means that only A may be used, only B may be used, or a combination of A and B may be used. Further, in the present specification, in a case where three or more matters are expressed by being connected by “and/or”, the same concept as “A and/or B” is applied.

All documents, patent applications, and technical standards described in the present specification are incorporated by reference in the present specification to the same extent as in a case where the incorporation of each individual document, patent application, and technical standard by reference is specifically and individually described.

What is claimed is:

1. An exposure control device comprising:
a processor,
wherein the processor is configured to perform exposure correction processing according to a difference between a maximum brightness value of a phase-difference detection pixel in a set region and a saturation level.

2. The exposure control device according to claim 1,
wherein the processor is configured to:
calculate an exposure correction amount based on the difference, as the exposure correction processing; and
perform exposure to the phase-difference detection pixel based on the exposure correction amount.

3. The exposure control device according to claim 1,
wherein the saturation level is set to a value of an upper limit at which the maximum brightness value of the phase-difference detection pixel in the set region is not saturated.

4. The exposure control device according to claim 1,
wherein the processor is configured to change the saturation level according to a subject.

5. The exposure control device according to claim 4,
wherein the processor is configured to change the saturation level according to a subject class determined by a machine learning model.

6. The exposure control device according to claim 4,
wherein a filter of a specific color is disposed in the phase-difference detection pixel, and
the processor is configured to set, in a case where a ratio of the subject of the specific color is equal to or greater than a first threshold value set in advance, the saturation level higher than in a case where the ratio of the subject of the specific color is less than the first threshold value.

7. The exposure control device according to claim 1,
wherein the processor is configured to calculate the maximum brightness value of the phase-difference detection pixel from a maximum brightness value of a normal pixel in the set region in a case where a subject is imaged with the normal pixel at a set exposure.

8. The exposure control device according to claim 7,
wherein the maximum brightness value of the normal pixel is obtained by comparing any one of individual brightness values of the normal pixel in the set region, average values of the brightness values of a plurality of the normal pixels that are adjacent to or close to each other in the set region, or maximum values of the brightness values of the plurality of the normal pixels that are adjacent to or close to each other in the set region.

9. The exposure control device according to claim 7,
wherein the processor is configured to calculate the maximum brightness value of the phase-difference detection pixel by multiplying a sensitivity ratio between the normal pixel and the phase-difference detection pixel by the maximum brightness value of the normal pixel.

10. The exposure control device according to claim 9,
wherein the sensitivity ratio is changed according to a position of the normal pixel having the maximum brightness value.

11. The exposure control device according to claim 9,
wherein the sensitivity ratio is changed according to a position of the set region.

12. The exposure control device according to claim 7,
wherein the processor is configured to change the set region in a case of a backlit scene.

13. The exposure control device according to claim 12,
wherein the processor is configured to set, in a case of the backlit scene, the set region to be narrower than in a case of a scene other than the backlit scene.

14. The exposure control device according to claim 7,
wherein the processor is configured to, in a case where there are two peaks of a distribution of brightness values of the normal pixels in the set region or in a case where there are a plurality of inflection points of the distribution, employ a maximum brightness value at a peak on a low brightness side among the peaks of the distribution as the maximum brightness value of the normal pixel used in a case of calculating the maximum brightness value of the phase-difference detection pixel.

15. The exposure control device according to claim 14,
wherein the processor is configured to, in a case of a backlit scene or a night scene, employ the maximum brightness value at the peak on the low brightness side as the maximum brightness value of the normal pixel used in a case of calculating the maximum brightness value of the phase-difference detection pixel.

16. The exposure control device according to claim 7,
wherein the processor is configured to employ a median value of the maximum brightness values of the normal pixels obtained in a plurality of consecutive frames as the maximum brightness value of the normal pixel used in a case of calculating the maximum brightness value of the phase-difference detection pixel.

17. The exposure control device according to claim 1,
wherein, the processor is configured to:
detect normal pixels that have reached the saturation level in the set region; and
in a case where a ratio of the normal pixels that have reached the saturation level is equal to or less than a second threshold value set in advance, perform exposure correction processing according to the difference.

18. The exposure control device according to claim 17,
wherein the processor is configured to:
determine whether a distribution of the normal pixels that have reached the saturation level is sparse or dense;
perform the exposure correction processing according to the difference in a case where the ratio is determined to be larger than the second threshold value and the distribution is determined to be sparse;
perform the exposure correction processing according to a set exposure correction amount set in advance in a case where the ratio is determined to be larger than the second threshold value, the distribution is determined to be dense, and the ratio of the normal pixels in which the distribution is determined to be dense is less than a third threshold value set in advance; and
not perform the exposure correction processing in a case where the ratio is determined to be larger than the second threshold value, the distribution is determined to be dense, and the ratio of the normal pixels in which the distribution is determined to be dense is equal to or larger than the third threshold value.

19. An operation method for an exposure control device comprising:
performing exposure correction processing according to a difference between a maximum brightness value of a phase-difference detection pixel in a set region and a saturation level.

20. A non-transitory computer-readable storage medium storing an operation program for an exposure control device, the program causing a computer to execute a process comprising:
performing exposure correction processing according to a difference between a maximum brightness value of a phase-difference detection pixel in a set region and a saturation level.
